(19) United States
(12) Patent Application Publication
(10) Pub. No.: US 2025/0184758 A1
(43) Pub. Date: Jun. 5, 2025

(54) COMMUNICATION METHOD

(71) Applicant: KYOCERA Corporation, Kyoto (JP)

(72) Inventors: Masato FUJISHIRO, Yokohama-shi (JP); Chiharu YAMAZAKI, Tokyo (JP); Amit KALHAN, San Diego, CA (US)

(73) Assignee: KYOCERA Corporation, Kyoto (JP)

(21) Appl. No.: 19/048,336

(22) Filed: Feb. 7, 2025

Related U.S. Application Data
(63) Continuation of application No. PCT/JP2023/028755, filed on Aug. 7, 2023.
(60) Provisional application No. 63/395,923, filed on Aug. 8, 2022.

(51) Int. Cl. H04W 16/26; H04B 7/04; H04W 16/28

(52) U.S. Cl. CPC H04W 16/26; H04B 7/04026; H04W 16/28

(57) ABSTRACT

A communication method used in a mobile communication system including a relay apparatus configured to be controlled by a network includes relaying, by one or more repeaters included in the relay apparatus, a radio signal from a base station to a user equipment through beamforming, and controlling, by a control terminal included in the relay apparatus, the repeater by performing wireless communication with the base station. The one or more repeaters include multiple elements to which control values for controlling a propagation state of a radio signal are applicable respectively. The controlling includes specifying a codebook based on a configuration from the base station, the codebook defining a control value set as a set of the control values for each index value.

### RELATED APPLICATIONS

The present application is a continuation based on PCT Application No. PCT/JP2023/028755, filed on Aug. 7, 2023, which claims the benefit of U.S. Provisional Patent Application No. 63/395,923 filed on Aug. 8, 2022. The content of which is incorporated by reference herein in their entirety.

### TECHNICAL FIELD

The present disclosure relates to a communication method used in a mobile communication system.

### BACKGROUND

In recent years, a mobile communication system of the fifth generation (5G) has been attracting attention. New Radio (NR), which is a radio access technology of the 5G system, is capable of broadband transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus is attracting attention that is a kind of relay apparatuses relaying radio signals between a base station and a user equipment, and can be controlled from a network (see, for example, Non-Patent Document 1). Such a repeater apparatus can extend the coverage of the base station while mitigating occurrence of interference by, for example, amplifying a radio signal received from the base station and transmitting the radio signal through directional transmission.

### CITATION LIST

### Non-Patent Literature

Non-Patent Document 1: 3GPP Contribution: RP-213700, “New SI: Study on NR Network-controlled Repeaters”

### SUMMARY

In a first aspect, a communication method is a communication method used in a mobile communication system including a relay apparatus configured to be controlled by a network and includes relaying, by one or more repeaters included in the relay apparatus, a radio signal from a base station to a user equipment through beamforming, and controlling, by a control terminal included in the relay apparatus, the repeater by performing wireless communication with the base station. The one or more repeaters include multiple elements to which control values for controlling a propagation state of a radio signal are applicable respectively. The controlling includes specifying a codebook based on a configuration from the base station, the codebook defining a control value set as a set of the control values for each index value.

In a second aspect, a communication method is a communication method used in a mobile communication system including a relay apparatus configured to be controlled by a network and includes relaying, by one or more repeaters included in the relay apparatus, a radio signal from a base station to a user equipment through beamforming, and controlling, by a control terminal included in the relay apparatus, the repeater by performing wireless communication with the base station. The one or more repeaters include multiple elements to which control values for controlling a propagation state of a radio signal are applicable respectively. The controlling includes specifying a common control value set derived from multiple control value sets including a first control value set to form a first beam and a second control value set to form a second beam having a beam direction different from a beam direction of the first beam.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a radio interface of a user plane handling data.

FIG. 3 is a diagram illustrating a configuration of a protocol stack of a radio interface of a control plane handling signaling (control signal).

FIG. 4 is a diagram illustrating an example of an application scenario for a relay apparatus (NCR apparatus) according to a first embodiment.

FIG. 5 is a diagram illustrating an example of the application scenario for the relay apparatus (NCR apparatus) according to the first embodiment.

FIG. 6 is a diagram illustrating an example of a control method of the relay apparatus (NCR apparatus) according to the first embodiment.

FIG. 7 is a diagram illustrating a configuration example of a protocol stack in a mobile communication system that includes the relay apparatus (NCR apparatus) according to the first embodiment.

FIG. 8 is a diagram illustrating a configuration example of the relay apparatus (NCR apparatus) according to the first embodiment.

FIG. 9 is a diagram illustrating a configuration example of a base station (gNB) according to an embodiment.

FIG. 10 is a diagram illustrating an example of downlink signaling from the base station (gNB) to a control terminal (NCR-MT) according to the first embodiment.

FIG. 11 is a diagram illustrating an example of uplink signaling from the control terminal (NCR-MT) to the base station (gNB) according to the first embodiment.

FIG. 12 is a diagram illustrating an example of a general operation sequence of the mobile communication system according to the first embodiment.

FIG. 13 is a diagram for describing beam sweeping according to the first embodiment.

FIG. 14 is a diagram for describing another example of the beam sweeping according to the embodiment.

FIG. 15 is a diagram illustrating a first configuration example of an NCR apparatus for simultaneously forming multiple beams.

FIG. 16 is a diagram illustrating a second configuration example the NCR apparatus for simultaneously forming multiple beams.

FIGS. 17A and 17B are diagrams illustrating examples of a codebook used in the NCR apparatus according to the first embodiment.

FIG. 18 is a diagram illustrating a first operation example for the codebook used in the NCR apparatus according to the first embodiment.

FIG. 19 is a diagram illustrating a second operation example for the codebook used in the NCR apparatus according to the first embodiment.

FIG. 20 is a diagram illustrating a third operation example for the codebook used in the NCR apparatus according to the first embodiment.

FIG. 21 is a diagram illustrating an example in which the NCR apparatus according to the first embodiment simultaneously forms two beams using two antenna sets.

FIG. 22 is a diagram illustrating an example in which the NCR apparatus according to the first embodiment simultaneously forms two beams using one antenna set with a common weight set.

FIG. 23 is a diagram illustrating a first operation example of a multi-beam operation of the NCR apparatus according to the first embodiment.

FIG. 24 is a diagram illustrating a second operation example of the multi-beam operation of the NCR apparatus according to the first embodiment.

FIG. 25 is a diagram for describing a relay apparatus according to a second embodiment.

FIG. 26 is a diagram for describing a relay apparatus according to a second embodiment.

FIG. 27 is a diagram for describing the relay apparatus according to the second embodiment.

FIG. 28 is a diagram illustrating a model of a network-controlled repeater.

FIG. 29 is a diagram illustrating a protocol stack focusing on a C-plane of the NCR-MT.

FIG. 30 is a diagram illustrating a multi-beam NCR.

FIG. 31 is a diagram illustrating options for a management model of a multi-beam repeater.

FIG. 32 is a diagram illustrating a CA/DC configuration of the NCR-MT.

### DESCRIPTION OF EMBODIMENTS

When a relay apparatus such as a repeater apparatus is controlled from a network, a control technique for specifically controlling the relay apparatus has not yet been established, and efficient coverage extension is currently difficult to perform using the relay apparatus.

The present disclosure provides an appropriately controllable relay apparatus that performs relay transmission between a base station and a user equipment.

A mobile communication system according to an embodiment is described with reference to the drawings. In the description of the drawings, the same or similar parts are denoted by the same or similar reference signs.

### (1) First Embodiment

A first embodiment is described first. The relay apparatus according to the first embodiment is a repeater apparatus that can be controlled from a network.

### (1.1) Mobile Communication System Overview

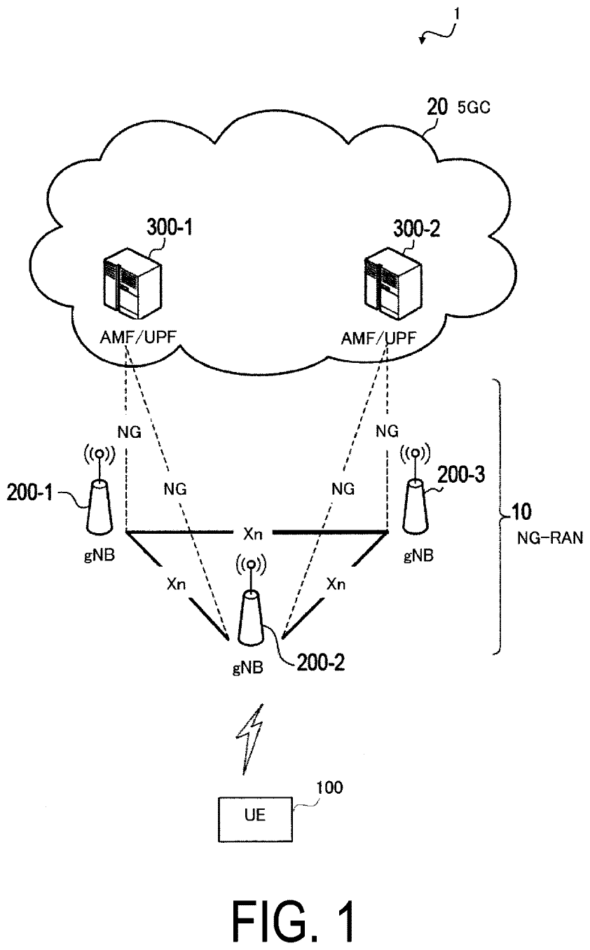

FIG. 1 is a diagram illustrating a configuration of a mobile communication system according to the first embodiment. A mobile communication system 1 complies with the 5th Generation System (5GS) of the 3rd Generation Partnership Project (3GPP) (registered trade name; the same applies below) standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

The gNB 200 may be divided into a Central Unit (CU) and a Distributed Unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to a neighboring base station via an Xn interface which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

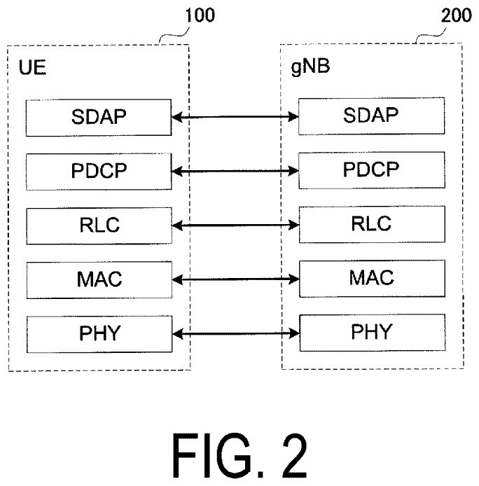

FIG. 2 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The gNB 200 transmits a synchronization signal block (SSB: Synchronization Signal/PBCH block). For example, the SSB includes four consecutive Orthogonal Frequency Division Multiplex (OFDM) symbols, in which a primary synchronization signal (PSS), a secondary synchronization signal (SSS), a physical broadcast channel (PBCH)/master information block (MIB), and a demodulation reference signal (DMRS) of the PBCH are arranged. A bandwidth of the SSB is, for example, a bandwidth of 240 consecutive subcarriers, that is, 20 RBs.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

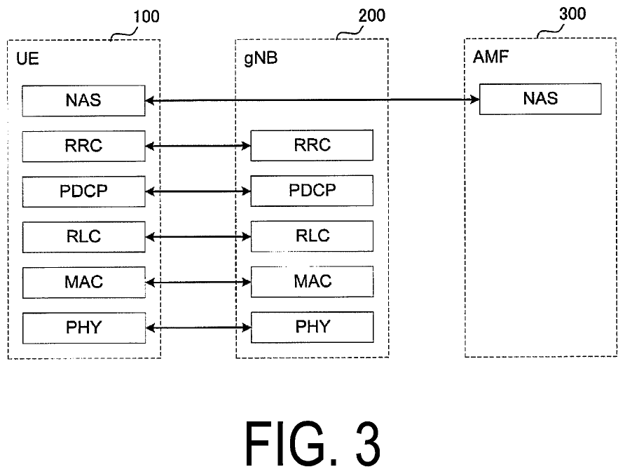

FIG. 3 is a diagram illustrating a configuration of a protocol stack of a radio interface of a control plane handling signaling (a control signal).

The protocol stack of the radio interface of the control plane includes a radio resource control (RRC) layer and a non-access stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

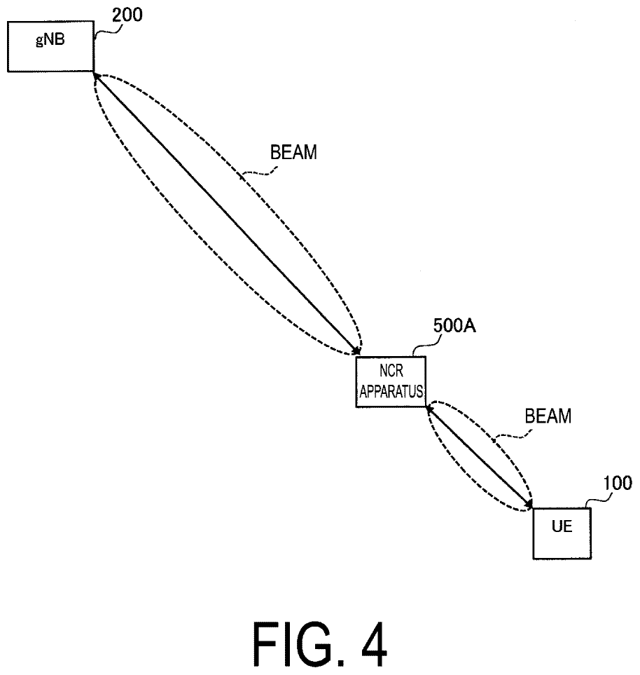

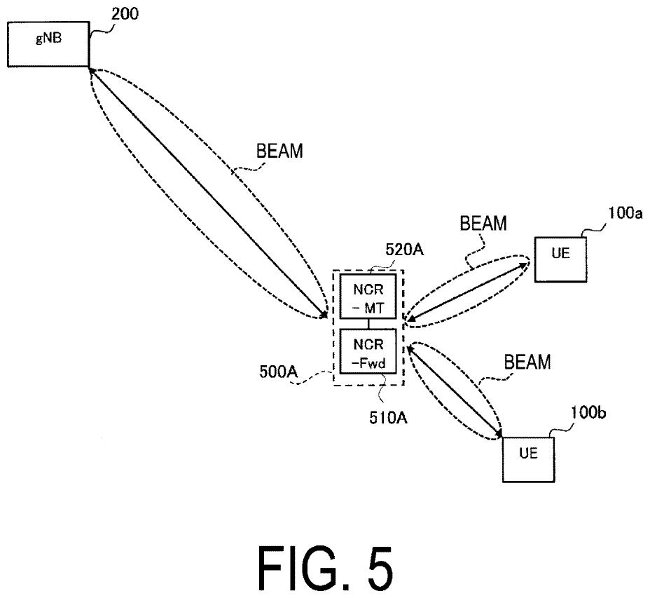

(1.2) Example of Application Scenario for Relay Apparatus FIGS. 4 and 5 are diagrams illustrating examples of an application scenario for an NCR apparatus according to the first embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, a UE 100 may be located outside a coverage area of the gNB 200, for example, outside an area where the UE 100 can receive radio signals directly from the gNB 200. The UE 100 may be in a state where communication with the gNB 200 cannot be performed within a line of sight because of obstacles existing between the gNB 200 and the UE 100.

As illustrated in FIG. 4, a repeater apparatus (500A) is a type of a relay apparatus relaying radio signals between the gNB 200 and the UE 100, and can be controlled from the network. The repeater apparatus (500A) is introduced into the mobile communication system 1. Hereinafter, such a repeater apparatus is referred to as a Network-Controlled Repeater (NCR) apparatus. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation/modulation and transmits the amplified radio signal through directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200. Although in the first embodiment, it is mainly assumed that the NCR apparatus 500A is applied to downlink communication from the gNB 200 to the UE 100, the NCR apparatus 500A can also be applied to uplink communication from the UE 100 to the gNB 200.

As illustrated in FIG. 5, a new UE (hereinafter referred to as an “NCR-Mobile termination (MT)”) 520A is introduced that is a type of a control terminal for controlling the NCR apparatus 500A. Specifically, the NCR apparatus 500A includes an NCR-Forward (Fwd) 510A and an NCR-MT 520A. The NCR-Fwd 510A is a kind of a repeater that relays a radio signal transmitted between the gNB 200 and the UE 100, to be more specific, changes a propagation state of the radio signal without demodulating or modulating the radio signal. The NCR-MT 520A performs radio communication with the gNB 200 to control the NCR-Fwd 510A. In this manner, the NCR-MT 520A controls the NCR apparatus 500A in cooperation with the gNB 200 by establishing a radio connection to the gNB 200 and performing wireless communication with the gNB 200. By doing so, efficient coverage extension can be achieved using the NCR apparatus 500A. The NCR-MT 520A controls the NCR apparatus 500A in accordance with control from the gNB 200.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wirelessly. The NCR-MT 520A may be configured to be integrated with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed in, for example, a vehicle to be movable. One NCR-MT 520A may control multiple NCR-Fwds 510A.

In the example illustrated in FIG. 5, the NCR apparatus 500A (NCR-Fwd 510A) dynamically or semi-statically changes a beam for transmission or reception. For example, the NCR-Fwd 510A forms a beam toward each of a UE 100a and a UE 100b. The NCR-Fwd 510A may form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits a radio signal received from the gNB 200 toward the UE 100b through beamforming and/or transmits a radio signal received from the UE 100b toward the gNB 200 through beamforming. Instead of or in addition to the beamforming, the NCR-Fwd 510A may perform null forming (so-called null steering) toward a UE 100 which is not a communication partner (not illustrated) and/or a neighboring gNB 200 (not illustrated) to suppress the interference.

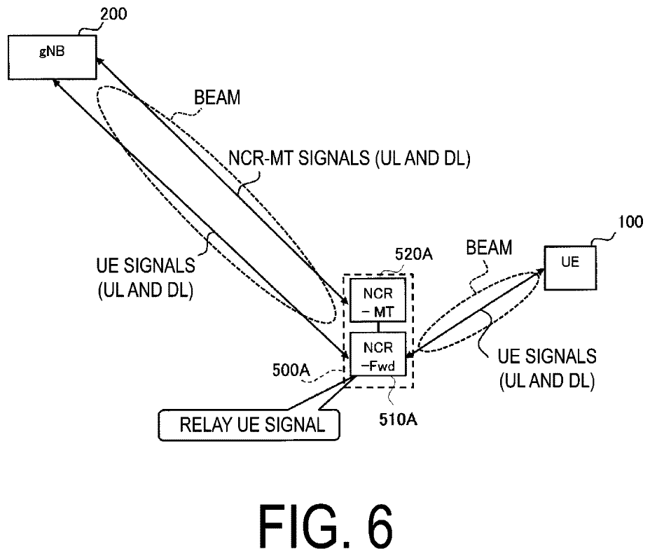

FIG. 6 is a diagram illustrating a control method of the NCR apparatus 500A according to the first embodiment. As illustrated in FIG. 6, the NCR-Fwd 510A relays a radio signal (referred to as a “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and receives radio signals (referred to herein as “NCR-MT signals”) to and from the gNB 200. The NCR-MT signal includes an uplink signal transmitted from the NCR-MT 520A to the gNB 200 (referred to as an “NCR-MT-UL signal”) and a downlink signal transmitted from the gNB 200 to the NCR-MT 520A (referred to as an “NCR-MT-DL signal”). The NCR-MT-UL signal includes signaling for controlling the NCR apparatus 500A. A radio link between the NCR-MT 520A and the gNB 200 is also referred to as a “control link”.

The gNB 200 directs a beam to the NCR-MT 520A, based on the NCR-MT-UL signal from the NCR-MT 520A. The NCR apparatus 500A and the NCR-MT 520A are co-located, and thus directing, by the gNB 200, a beam to the NCR-MT 520A results in directing the beam also to the NCR-Fwd 510A when frequencies of the backhaul link and the control link are the same. The gNB 200 transmits the NCR-MT-DL signal and the UE-DL signal using the beam. The NCR-MT 520A receives the NCR-MT-DL signal. Note that, when the NCR-Fwd 510A and NCR-MT 520A are at least partially integrated with each other, in the NCR-Fwd 510A and NCR-MT 520A, functions of transmitting and receiving or relaying UE signals and/or NCR-MT signals (e.g., antennas) may be integrated together. The beam includes a transmission beam and/or a reception beam. The beam is a general term for transmission and/or reception under control for maximizing power of a transmission wave and/or a reception wave in a specific direction by adjusting/adapting an antenna weight or the like.

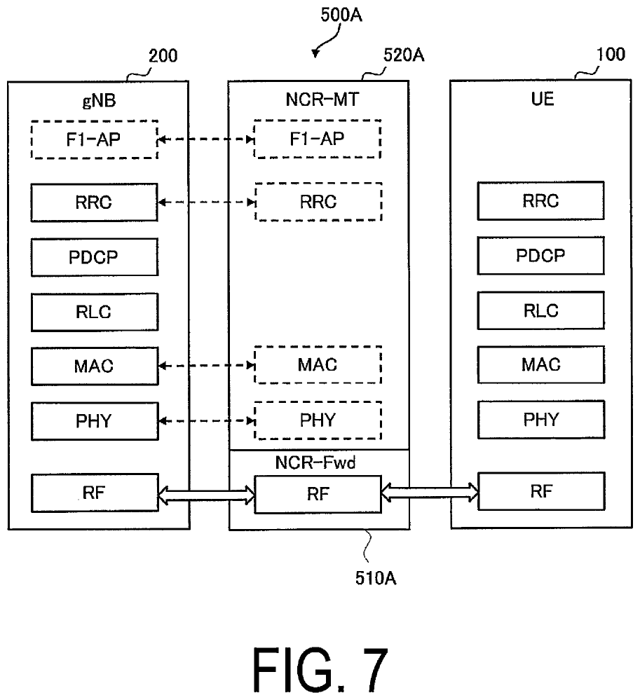

FIG. 7 is a diagram illustrating a configuration example of a protocol stack in the mobile communication system 1 that includes the NCR apparatus 500A according to the first embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) selected from the group consisting of PHY, MAC, RRC, and F1-AP (Application Protocol). The F1-AP is a type of a fronthaul interface. The NCR-MT 520A communicates downlink signaling and/or uplink signaling, which will be described below, with the gNB 200 through at least one selected from the group consisting of the PHY, the MAC, RRC, and the F1-AP. When the NCR-MT 520A is a type or a part of the base station, the NCR-MT 520A may communicate with the gNB 200 through an AP of Xn (Xn-AP) which is an inter-base station interface.

### (1.3) Configuration Example of Relay Apparatus

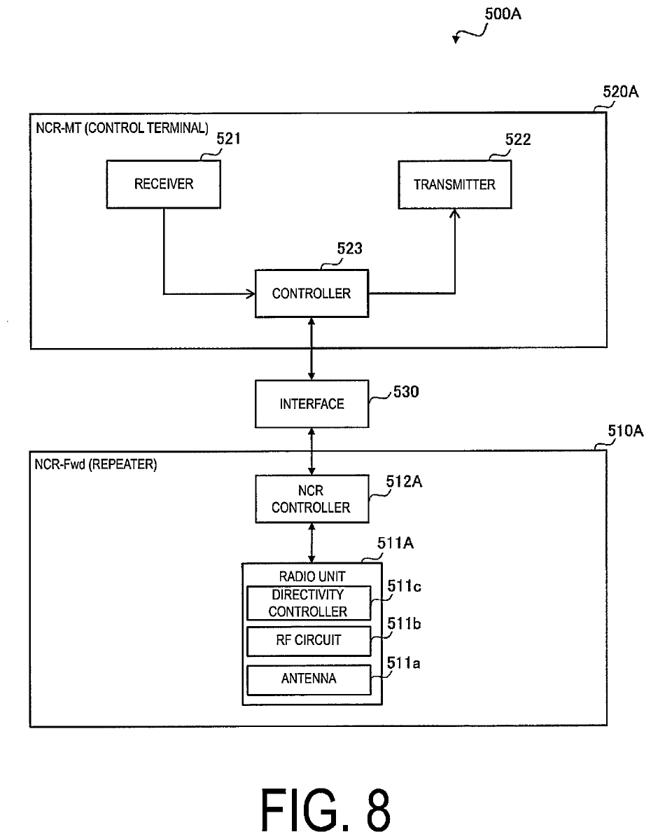

FIG. 8 is a diagram illustrating a configuration example of the NCR apparatus 500A as the relay apparatus according to the first embodiment. The NCR apparatus 500A includes the NCR-Fwd 510A, the NCR-MT 520A, and an interface 530.

The NCR-Fwd 510A includes a radio unit 511A and an NCR controller 512A. The radio unit 511A includes an antenna 511a including multiple antennas (multiple antenna elements), an RF circuit 511b including an amplifier, and a directivity controller 511c controlling directivity of the antenna 511a. The RF circuit 511b amplifies and relays (transmits) radio signals transmitted and received by the antenna 511a. The RF circuit 511b may convert a radio signal, which is an analog signal, into a digital signal, and may reconvert the digital signal into an analog signal after digital signal processing. The directivity controller 511c may perform analog beamforming by analog signal processing. The directivity controller 511c may perform digital beamforming by digital signal processing. The directivity controller 511c may perform analog and digital hybrid beamforming. The NCR controller 512A controls the radio unit 511A in response to a control signal from the NCR-MT 520A. The NCR controller 512A may include at least one processor. The NCR controller 512A may output information relating to a capability of the NCR apparatus 500A to the NCR-MT 520A.

The NCR-MT 520A includes a receiver 521, a transmitter 522, and a controller 523. The receiver 521 performs various types of reception under control of the controller 523. The receiver 521 includes an antenna and a reception device. The reception device converts a radio signal (radio signal) received through the antenna into a baseband signal (a reception signal) and outputs the resulting signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the resulting signal through the antenna. The controller 523 performs various types of controls in the NCR-MT 520A. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like on a baseband signal. The CPU executes the program stored in the memory to thereby perform various types of processing. The controller 523 performs a function of at least one layer selected from the group consisting of the PHY, the MAC, the RRC, and the F1-AP.

The interface 530 electrically connects the NCR-Fwd 510A and the NCR-MT 520A. The controller 523 of the NCR-MT 520A controls the NCR-Fwd 510A via the interface 530. In the first embodiment, the receiver 521 of the NCR-MT 520A receives signaling (downlink signaling) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

In the first embodiment, the controller 523 of the NCR-MT 520A may transmit the NCR capability information indicating the capability of the NCR apparatus 500A to the gNB 200 through wireless communication. The NCR capability information is an example of the uplink signaling from the NCR-MT 520A to the gNB 200. This enables the gNB 200 to recognize the capability of the NCR apparatus 500A.

### (1.4) Configuration Example of Base Station

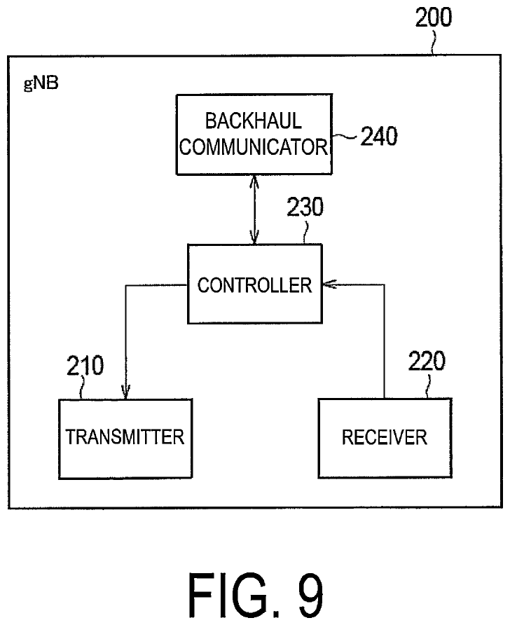

FIG. 9 is a diagram illustrating a configuration example of the gNB 200 according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using multiple antennas.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like on a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

In the first embodiment, the transmitter 210 of the gNB 200 transmits signaling (downlink signaling) used to control the NCR-Fwd 510A to the NCR-MT 520A through wireless communication. This enables the gNB 200 to control the NCR apparatus 500A via the NCR-MT 520A. In the first embodiment, the receiver 220 of the gNB 200 may receive the NCR capability information indicating the capability of the NCR apparatus 500A from the NCR-MT 520A through wireless communication.

### (1.5) Example of Downlink Signaling

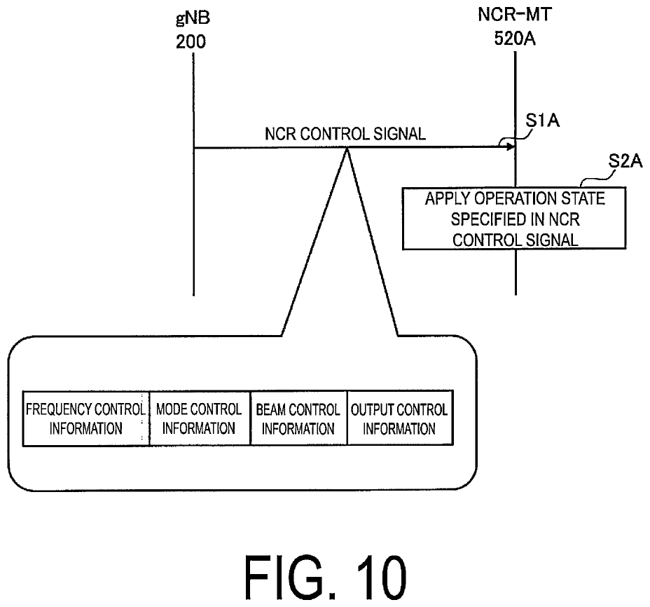

FIG. 10 is a diagram illustrating an example of the downlink signaling from the gNB 200 to the NCR-MT 520A according to the first embodiment.

The gNB 200 (transmitter 210) transmits downlink signaling to the NCR-MT 520A. The downlink signaling may be an RRC message that is RRC layer (i.e., layer-3) signaling. The downlink signaling may be a MAC Control Element (CE) that is MAC layer (i.e., layer-2) signaling. The downlink signaling may be downlink control information (DCI) that is PHY layer (i.e., layer-1) signaling. The downlink signaling may be UE-specific signaling. The downlink signaling may be broadcast signaling. The downlink signaling may be a fronthaul message (for example, F1-AP message). When the NCR-MT 520A is a type or a part of the base station, the NCR-MT 520A may communicate with the gNB 200 through an AP of Xn (Xn-AP) which is an inter-base station interface.

For example, the gNB 200 (transmitter 210) transmits an NCR control signal designating an operation state of the NCR apparatus 500A as the downlink signaling to the NCR-MT 520A having established a radio connection to the gNB 200 (step S1A). The NCR control signal designating the operation state of the NCR apparatus 500A may be the MAC CE that is the MAC layer (layer-2) signaling or the DCI that is the PHY layer (layer-1) signaling. However, the NCR control signal may be included in an RRC Reconfiguration message that is a type of a UE-specific RRC message to transmit to the NCR-MT 520A. The downlink signaling may be a message of a layer (for example, an NCR application) higher than the RRC layer. The downlink signaling may be transmitting a message of a layer higher than the RRC layer encapsulated with a message of a layer equal to or lower than the RRC layer. Note that the NCR-MT 520A (transmitter 522) may transmit a response message with respect to the downlink signaling from the gNB 200 in the uplink. The response message may be transmitted in response to the NCR apparatus 500A completing the configuration designated in the downlink signaling or receiving the configuration. The NCR control signal may be referred to as Side Control Information.

The NCR control signal may include frequency control information to designate a center frequency of a radio signal (for example, a component carrier) that is a target to be relayed by the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal as the target to be relayed that has a center frequency indicated by the frequency control information (step S2A). The NCR control signal may include multiple pieces of frequency control information to designate center frequencies different from each other. Since the NCR control signal includes the frequency control information, the gNB 200 can designate the center frequency of the radio signal that is the target to be relayed by the NCR-Fwd 510A via the NCR-MT 520A.

The NCR control signal may include mode control information to designate an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) or a null steering mode (that is, a mode in which suppression of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, the mode in which the NCR apparatus 500A performs non-directional transmission and/or reception is a mode in which the NCR-Fwd 510A performs relay in all directions and may be referred to as an omnidirectional mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to multiple antennas. Any of these modes may be designated (configured) from the gNB 200 to the NCR-MT 520A. The mode in which the NCR-Fwd 510A performs transmission and/or reception with a variable directional beam may be a mode for performing analog beamforming. The mode may be a mode in which hybrid beamforming is performed. The mode may be a mode in which hybrid beamforming is performed. The mode may be a mode for forming an adaptive beam specific to the UE 100. Any of these modes may be designated (configured) from the gNB 200 to the NCR-MT 520A. Note that in the operation mode in which beamforming is performed, beam control information described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (configured) from the gNB 200 to the NCR-MT 520A. The operation mode may include a mode in which relay transmission by the NCR-Fwd 510A is turned on (activated) and a mode in which relay transmission by the NCR-Fwd 510A is turned off (deactivated). Any of these modes may be designated (configured) from the gNB 200 to the NCR-MT 520A in the NCR control signal.

The NCR control signal may include the beam control information to designate a transmission direction, a transmission weight (hereinafter, also referred to as a unit “weight”), or a beam pattern for the NCR-Fwd 510A to perform directional transmission. The beam control information may be associated with the frequency control information (center frequency). The beam control information may include a Precoding Matrix Indicator (PMI). The beam control information may include beam forming angle information. When the NCR control signal received from the gNB 200 includes the beam control information, the NCR-MT 520A (controller 523) controls the NCR-Fwd 510A such that the NCR-Fwd 510A forms a transmission directivity (beam) indicated by the beam control information (step S2A). Since the NCR control signal includes the beam control information, the gNB 200 can control the transmission directivity of the NCR apparatus 500A via the NCR-MT 520A.

The NCR control signal may include output control information to designate a degree for the NCR-Fwd 510A to amplify a radio signal (amplification gain) or transmission power. The output control information may be information indicating a difference value (that is, a relative value) between the current amplification gain or transmission power and the target amplification gain or transmission power. When the NCR control signal received from the gNB 200 includes the output control information, the NCR-MT 520A (controller 523) controls the NCR-Fwd 510A such that the amplification gain or transmission power is changed to an amplification gain or transmission power indicated by the output control information (step S2A). The output control information may be associated with the frequency control information (center frequency). The output control information may be information to designate any one of an amplification gain, a beamforming gain, and an antenna gain of the NCR-Fwd 510A. The output control information may be information to designate the transmission power of the NCR-Fwd 510A.

When one NCR-MT 520A controls multiple NCR-Fwds 510A, the gNB 200 (transmitter 210) may transmit the NCR control signal for each of the NCR-Fwds 510A to the NCR-MT 520A. In this case, the NCR control signal may include an identifier of the corresponding NCR-Fwd 510A (NCR identifier). The NCR-MT 520A (controller 523) controlling the multiple NCR-Fwds 510A determines the NCR-Fwd 510A to which the NCR control signal received from the gNB 200 is applied, based on the NCR identifier included in the received NCR control signal. Note that the NCR identifier may be transmitted together with the NCR control signal from the NCR-MT 520A to the gNB 200 even when the NCR-MT 520A controls only one NCR-Fwd 510A.

As described above, the NCR-MT 520A (controller 523) controls the NCR-Fwd 510A based on the NCR control signal from the gNB 200. This enables the gNB 200 to control the NCR-Fwd 510A via the NCR-MT 520A.

### (1.6) Example of Uplink Signaling

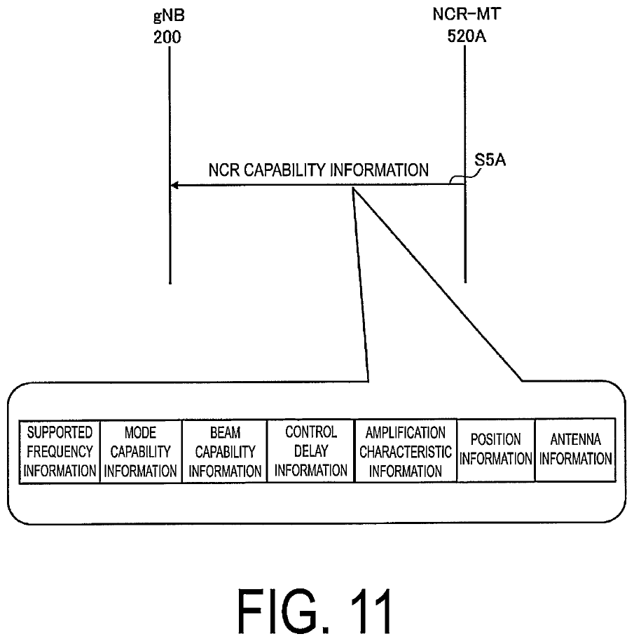

FIG. 11 is a diagram illustrating an example of the uplink signaling from the NCR-MT 520A to the gNB 200 according to the first embodiment.

The NCR-MT 520A (transmitter 210) transmits uplink signaling to the gNB 200. The uplink signaling may be an RRC message that is RRC layer signaling. The uplink signaling may be a MAC CE that is MAC layer signaling. The uplink signaling may be uplink control information (UCI) that is PHY layer signaling. The uplink signaling may be a fronthaul message (for example, F1-AP message). The uplink signaling may be an inter-base station message (for example, Xn-AP message). The uplink signaling may be a message of a layer (for example, an NCR application) higher than the RRC layer. The uplink signaling may be transmitting a message of a layer higher than the RRC layer encapsulated with a message of a layer equal to or lower than the RRC layer. That is, the uplink signaling stores a higher layer message in a lower layer container. Note that the gNB 200 (transmitter 210) may transmit a response message with respect to the uplink signaling from the NCR-MT 520A in the downlink, and the NCR-MT 520A (receiver 521) may receive the response message.

For example, the NCR-MT 520A (transmitter 522) having established a radio connection to the gNB 200 transmits the NCR capability information indicating the capability of the NCR apparatus 500A to the gNB 200 as the uplink signaling (step S5A). The NCR-MT 520A (transmitter 522) may include the NCR capability information in a UE Capability message or a UE Assistant Information message that is a type of the RRC message to transmit to the gNB 200. The NCR-MT 520A (transmitter 522) may transmit the NCR capability information (NCR capability information and/or operation state information) to the gNB 200 in response to a request or inquiry from the gNB 200.

The NCR capability information may include supported frequency information indicating a frequency supported by the NCR-Fwd 510A. The supported frequency information may be a numerical value or index indicating a center frequency of the frequency supported by the NCR-Fwd 510A. The supported frequency information may be a numerical value or index indicating a range of the frequencies supported by the NCR-Fwd 510A. When the NCR capability information received from the NCR-MT 520A includes the supported frequency information, the gNB 200 (controller 230) can recognize the frequency supported by the NCR-Fwd 510A, based on the supported frequency information. The gNB 200 (controller 230) may configure the center frequency of the radio signal that is the target to be relayed by the NCR apparatus 500A within the range of the frequencies supported by the NCR-Fwd 510A.

The NCR capability information may include mode capability information relating to the operation modes or switching between the operation modes that can be supported by the NCR-Fwd 510A. The operation mode may be, as described above, at least any one selected from the group consisting of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) or a null steering mode (that is, a mode in which suppression of an interference wave is emphasized). The mode capability information may be information indicating which operation mode among these operation modes the NCR-Fwd 510A can support. The mode capability information may be information indicating between which operation modes among these operation modes the mode switching is possible. When the NCR capability information received from the NCR-MT 520A includes the mode capability information, the gNB 200 (controller 230) can recognize the operation modes and mode switching supported by the NCR-Fwd 510A, based on the mode capability information. The gNB 200 (controller 230) may configure the operation mode of the NCR-Fwd 510A within a range of the recognized operation modes and mode switching.

The NCR capability information may include the beam capability information indicating a beam variable range, a beam variable resolution, or the number of variable patterns when the NCR-Fwd 510A performs transmission and/or reception with a variable directional beam. The beam capability information may be, for example, information indicating a variable range of a beam angle with respect to the horizontal direction or the vertical direction (for example, being controllable from 30° to) 90°. The beam capability information may be information indicating an absolute angle. The beam capability information may be represented by a direction and/or an elevation angle at which a beam is directed. The beam capability information may be information indicating an angular change for each variable step (for example, horizontal 5°/step, vertical 10°/step). The beam capability information may be information indicating the number of variable steps (for example, horizontal 10 steps and vertical 20 steps). The beam capability information may be information indicating the number of variable patterns of a beam in the NCR-Fwd 510A (for example, a total of 10 patterns of beam patterns 1 to 10). When the NCR capability information received from the NCR-MT 520A includes the beam capability information, the gNB 200 (controller 230) can recognize the beam angle change or beam patterns that can be supported by the NCR-Fwd 510A, based on the beam capability information. The gNB 200 (controller 230) may configure a beam of the NCR-Fwd 510A within a range of the recognized beam angle change or beam patterns. These pieces of beam capability information may be null capability information. For the null capability information, these pieces of beam capability information indicate a null control capability when null steering is performed.

The NCR capability information may include control delay information indicating a control delay time in the NCR apparatus 500A. For example, the control delay information is information indicating a delay time (for example, 1 ms, 10 ms . . . ) from a timing at which the UE 100 receives an NCR control signal or a timing at which the UE 100 transmits configuration completion for the NCR control signal to the gNB 200 until the UE 100 completes control (change of the operation mode and/or change of the beam) according to the NCR control signal. When the NCR capability information received from the NCR-MT 520A includes the control delay information, the gNB 200 (controller 230) can recognize the control delay time in the NCR-Fwd 510A, based on the control delay information.

The NCR capability information may include amplification characteristic information relating to radio signal amplification characteristics or output power characteristics in the NCR-Fwd 510A. The amplification characteristic information may be information indicating an amplifier gain (dB), a beamforming gain (dB), and an antenna gain (dBi) of the NCR-Fwd 510A. The amplification characteristic information may be information indicating an amplification variable range (for example, 0 dB to 60 dB) in the NCR-Fwd 510A. The amplification characteristic information may be information indicating the number of steps (for example, 10 steps) of the amplification degrees that can be changed by the NCR-Fwd 510A or the amplification degree for each variable step (for example, 10 dB/step). The amplification characteristic information may be information indicating an output power variable range (for example, 0 dBm to 30 dBm) of the NCR-Fwd 510A. The amplification characteristic information may be information indicating the number of steps (for example, 10 steps) of the output power that can be changed by the NCR-Fwd 510A or the output power for each variable step (for example, 10 dBm/step or 10 dB/step).

The NCR capability information may include position information indicating an installation location of the NCR apparatus 500A. The position information may include any one or more of latitude, longitude, and altitude. The position information may include information indicating a distance and/or an installation angle of the NCR apparatus 500A with respect to the gNB 200. The installation angle may be a relative angle with respect to the gNB 200, or a relative angle with respect to, for example, north, vertical, or horizontal. The installation location may be position information of a place where the antenna 511a of the NCR-Fwd 510A is installed.

The NCR capability information may include antenna information indicating the number of antennas included in the NCR-Fwd 510A. The antenna information may be information indicating the number of antenna ports included in the NCR-Fwd 510A. The antenna information may be information indicating a degree of freedom of the directivity control (beam or null formation). The degree of freedom indicates how many beams can be formed (controlled) and is usually “(the number of antennas)−1”. For example, in the case of two antennas, the degree of freedom is one. In the case of two antennas, an 8-shaped beam pattern is formed, but the directivity control can be performed only in one direction, so that the degree of freedom is one.

When the NCR-MT 520A controls multiple NCR-Fwds 510A, the NCR-MT 520A (transmitter 522) may transmit the NCR capability information for each NCR-Fwd 510A to the gNB 200. In this case, the NCR capability information may include the number of NCR-Fwds 510A and/or identifiers of the corresponding NCR-Fwds 510A (NCR identifiers). When the NCR-MT 520A controls multiple NCR-Fwds 510A, the NCR-MT 520A (transmitter 522) may transmit information indicating the respective identifiers of the multiple NCR-Fwds 510A and/or the number of the multiple NCR-Fwds 510A. Note that the NCR identifier may be transmitted together with the NCR capability information from the NCR-MT 520A to the gNB 200 even when the NCR-MT 520A controls only one NCR-Fwd 510A.

### (1.7) Example of General Operation Sequence

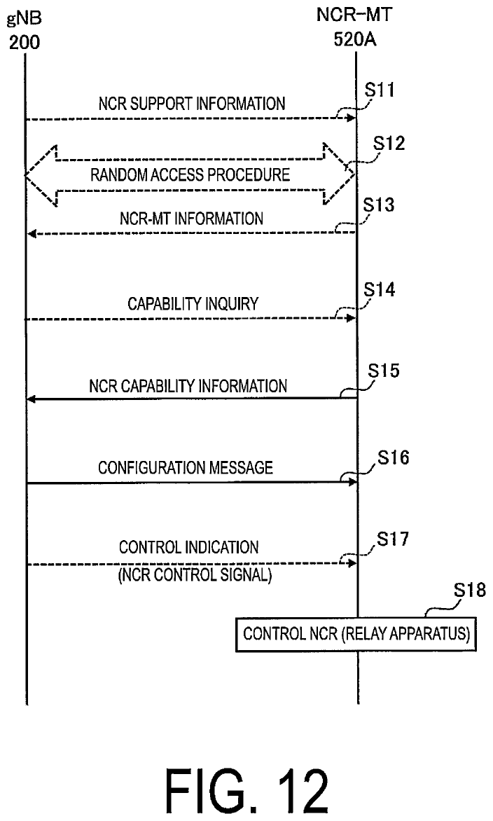

FIG. 12 is a diagram illustrating an example of a general operation sequence of the mobile communication system 1 according to the first embodiment. In the sequence diagram referred to in the embodiment described below, dashed lines indicate non-essential steps. Note that although description in detail will be given below, “NCR” in FIG. 12 may be interpreted as “RIS”.

In step S11, the gNB 200 (transmitter 210) broadcasts NCR support information indicating that the gNB 200 supports the NCR-MT 520A. For example, the gNB 200 (transmitter 210) broadcasts a system information block (SIB) including the NCR support information. The NCR support information may be information indicating that the NCR-MT 520A is accessible. The gNB 200 (transmitter 210) may broadcast NCR non-support information indicating that the gNB 200 does not support the NCR-MT 520A. The NCR non-support information may be information indicating that the NCR-MT 520A is inaccessible.

In this stage, the NCR-MT 520A may be in the RRC idle state or RRC inactive state. The NCR-MT 520A (controller 523) having not established a radio connection to the gNB 200 may determine that access to the gNB 200 is permitted in response to receiving the NCR support information from the gNB 200, and may perform an access operation to establish a radio connection to the gNB 200. The NCR-MT 520A (controller 523) may regard the gNB 200 (cell) to which access is permitted as the highest priority and perform cell reselection.

On the other hand, when the gNB 200 does not broadcast the NCR support information (or when the gNB 200 broadcasts the NCR non-support information), the NCR-MT 520A (controller 523) having not established a radio connection to the gNB 200 may determine that access (connection establishment) to the gNB 200 is not possible. This enables the NCR-MT 520A to establish a radio connection only to the gNB 200 capable of handling the NCR-MT 520A.

Note that when the gNB 200 is congested, the gNB 200 may broadcast access restriction information to restrict an access from the UE 100. However, unlike a normal UE 100, the NCR-MT 520A can be regarded as a network-side entity. Therefore, the NCR-MT 520A may ignore the access restriction information from the gNB 200. For example, the NCR-MT 520A (controller 523), when receiving the NCR support information from the gNB 200, may perform an operation to establish a radio connection to the gNB 200 even if the gNB 200 broadcasts the access restriction information. For example, the NCR-MT 520A (controller 523) may not need to perform (or may ignore) Unified Access Control (UAC). Alternatively, any one or both of Access Category/Access Identity (AC/AI) used in the UAC may be a special value indicating that the access is made by the NCR-MT.

In step S12, the NCR-MT 520A (controller 523) initiates a random access procedure for the gNB 200. In the random access procedure, the NCR-MT 520A (transmitter 522) transmits a random access preamble (Msg1) and an RRC message (Msg3) to the gNB 200. In the random access procedure, the NCR-MT 520A (receiver 521) receives a random access response (Msg2) and an RRC message (Msg4) from the gNB 200.

In step S13, when establishing a radio connection to the gNB 200, the NCR-MT 520A (transmitter 522) may transmit to the gNB 200 NCR-MT information indicating that the NCR-MT 520A itself is an NCR-MT. For example, the NCR-MT 520A (transmitter 522), during the random access procedure with the gNB 200, includes the NCR-MT information in the message (for example, Msg1, Msg3, Msg5) for the random access procedure to transmit to the gNB 200. The gNB 200 (controller 230) can recognize that the accessing UE 100 is the NCR-MT 520A, based on the NCR-MT information received from the NCR-MT 520A, and exclude from the access restriction target (in other words, accept the access from), for example, the NCR-MT 520A. When the random access procedure is completed, the NCR-MT 520A transitions from the RRC idle state or the RRC inactive state to the RRC connected state.

In step S14, the gNB 200 (transmitter 522) transmits a capability inquiry message to inquire the capability of the NCR-MT 520A to the NCR-MT 520A. The NCR-MT 520A (receiver 521) receives the capability inquiry message.

In step S15, the NCR-MT 520A (transmitter 522) transmits a capability information message including the NCR capability information to the gNB 200. The capability information message may be an RRC message, for example, a UE Capability message. The gNB 200 (receiver 220) receives the capability information message. The gNB 200 (controller 230) recognizes the capability of the NCR apparatus 500A based on the received capability information message.

In step S16, the gNB 200 (transmitter 522) transmits a configuration message including various configurations regarding the NCR apparatus 500A to the NCR-MT 520A.

The NCR-MT 520A (receiver 521) receives the configuration message. The configuration message is a type of the above-described downlink signaling. The configuration message may be an RRC message, for example an RRC reconfiguration message.

In step S17, the gNB 200 (transmitter 522) transmits the control indication designating the operation state of the NCR-Fwd 510A to the NCR-MT 520A. The control indication may be the NCR control signal (for example, L1/L2 signaling) described above. The NCR-MT 520A (receiver 521) receives the control indication. The NCR-MT 520A (controller 523) controls the NCR-Fwd 510A in response to the control indication.

In step S18, the NCR-MT 520A controls the NCR apparatus 500A according to the configuration (and control indication). The NCR-MT 520A may autonomously control the NCR apparatus 500A without depending on the control indication from the gNB 200. For example, the NCR-MT 520A may autonomously control the NCR apparatus 500A based on a position of the UE 100 and/or information received from the UE 100 by the NCR-MT 520A.

### (1.8) Beam Sweeping

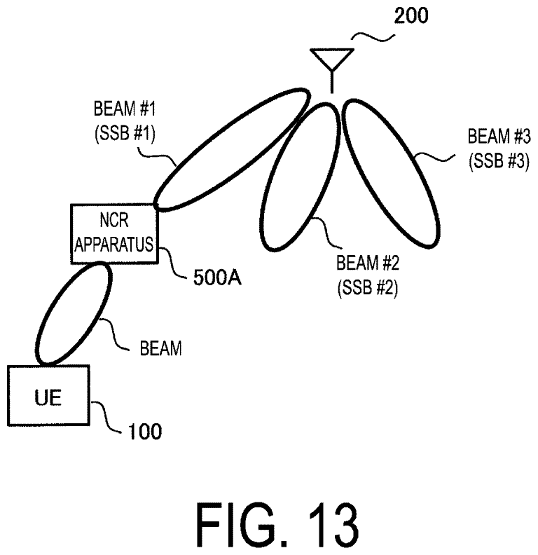

FIG. 13 is a diagram for describing an example of beam sweeping according to the embodiment.

The gNB 200 performs beam sweeping in which transmission is performed while sequentially switching beams in different directions. At this time, the gNB 200 transmits a different SSB for each beam. The SSB is periodically transmitted from the gNB 200 into the cell as an SSB burst including multiple SSBs. An SSB index, which is an identifier, is assigned to each of the multiple SSBs in one SSB burst. The SSBs are beamformed and transmitted in different directions. The NCR apparatus 500A (NCR-MT 520A) reports, to the gNB 200 during a Random Access Channel (RACH) procedure, in which direction the beam had a good reception quality. Specifically, the NCR apparatus 500A (NCR-MT 520A) transmits a random access preamble to the gNB 200 at a random access channel (RACH) occasion associated with the SSB index of which the beam had a good reception quality. As a result, the gNB 200 can recognize the optimum beam for the NCR apparatus 500A (NCR-MT 520A).

Such an SSB may be transmitted in the initial BWP (initial DL BWP). When the NCR apparatus 500A (NCR-MT 520A) is in the RRC connected state, a dedicated BWP may be configured and activated for the NCR apparatus 500A (NCR-MT 520A). In the dedicated BWP, a channel state information reference signal (CSI-RS) may be used as a reference signal instead of the SSB. Hereinafter, on the assumption that a beam and an SSB (specifically, an SSB index) have a one-to-one relationship, an example in which beam information for identifying a beam is an SSB index will be mainly described. However, the beam may be associated with the CSI-RS. The beam information for identifying a beam may be a CSI-RS index.

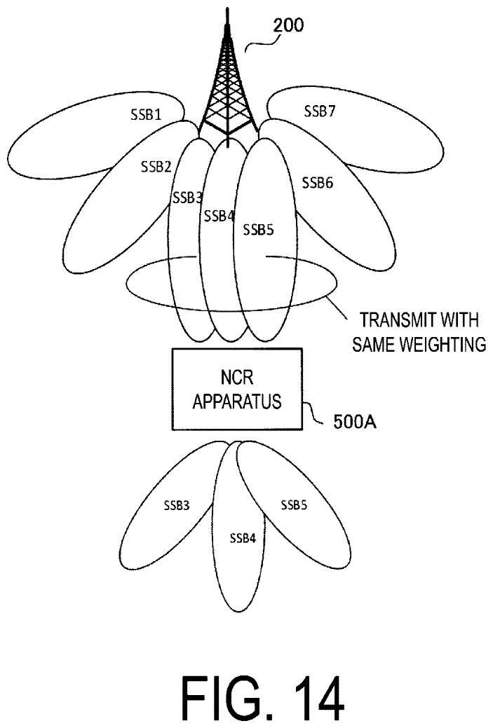

FIG. 14 is a diagram for describing another example of the beam sweeping according to the embodiment.

The gNB 200 transmits multiple SSBs at mutually different timings and in beams different from each other. FIG. 14 illustrate an example in which the gNB 200 transmits a total of seven SSBs from an SSB 1 to an SSB 7. Here, the gNB 200 transmits a set of an SSB 3 to an SSB 5 (hereinafter also referred to as an “SSB set”) with the same weighting (that is, in the same beam direction).

The NCR apparatus 500A, upon relaying a beam of the SSB 3, performs transmission toward the original beam direction of the SSB 3 through beamforming to which a weight set designated by the gNB 200 is applied. The weight set is a set consisting of weights for each antenna element. Note that each weight is an example of a “control value”, and a weight set consisting of multiple weights is an example of a “control value set”. Each weight is a value (coefficient) for adjusting a phase and/or an amplitude of the radio signal.

The NCR apparatus 500A, upon relaying a beam of the SSB 4, performs transmission toward the original beam direction of the SSB 4 through beamforming to which the weight set designated by the gNB 200 is applied. The NCR apparatus 500A, upon relaying a beam of the SSB 5, performs transmission toward the original beam direction of the SSB 5 through beamforming to which the weight set designated by the gNB 200 is applied.

In this manner, in the example of FIG. 14, the gNB 200 transmits multiple beams (beams of the SSB 3 to the SSB 5 in the illustrated example) with the same transmission weight in the direction of the NCR apparatus 500A for the backhaul link. The NCR apparatus 500A transmits the multiple beams (beams of the SSB 3 to the SSB 5) with different transmission weights in different directions for the access link.

### (1.9) Configuration Example of Relay Apparatus for Simultaneously Forming Multiple Beams

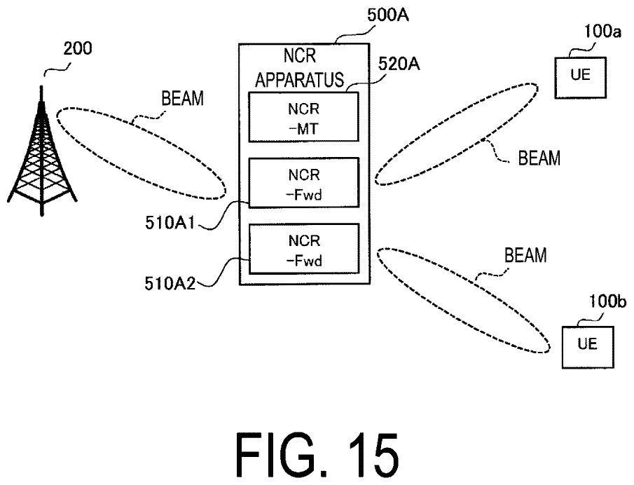

FIG. 15 is a diagram illustrating a first configuration example of the NCR apparatus 500A for simultaneously forming multiple beams. Note that although an example is mainly described below in which the NCR apparatus 500A forms a beam for each of two UEs 100, the NCR apparatus 500A may direct a beam to each of three or more UEs 100.

In the first configuration example, the NCR apparatus 500A includes one NCR-MT 520A and multiple NCR-Fwds 510A. The NCR-MT 520A controls the NCR-Fwd 510A by performing wireless communication with the gNB 200. In the illustrated example, the NCR apparatus 500A includes two NCR-Fwds 510A (510A1, 510A2), but the NCR apparatus 500A may include three or more NCR-Fwds 510A.

The NCR-MT 520A performs control such that the multiple NCR-Fwds 510A applies different weight sets to perform beamforming. For example, the NCR apparatus 500A simultaneously forms individual beams (independent beams) for the respective UEs 100a and 100b. For example, the NCR-Fwd 510A1 applies a first weight set to form a beam in the direction of the UE 100a. The NCR-Fwd 510A2 applies a second weight set to form a beam in the direction of the UE 100b. Thus, the NCR apparatus 500A can simultaneously form beams in multiple directions.

Here, the weight set is signaled by way of an NCR control signal from the gNB 200 to the NCR apparatus 500A (NCR-MT 520A). Since the weight set includes multiple weights, an amount of information may be large. Therefore, the gNB 200 transmits an NCR control signal including an index value indicating a weight set to the NCR apparatus 500A (NCR-MT 520A). The NCR apparatus 500A (NCR-MT 520A) holds a codebook for associating each weight set with an index value, and specifies a corresponding weight set from the index value received from the gNB 200 by use of the codebook.

For example, the gNB 200 transmits an NCR control signal including a set of an index value indicating the first weight set and an identifier of the NCR-Fwd 510A1 to the NCR apparatus 500A (NCR-MT 520A). The NCR apparatus 500A (NCR-MT 520A) controls the NCR-Fwd 510A1 such that the NCR-Fwd 510A1 applies the first weight set to perform beamforming based on the NCR control signal. The gNB 200 transmits an NCR control signal including a set of an index value indicating the second weight set and an identifier of the NCR-Fwd 510A2 to the NCR apparatus 500A (NCR-MT 520A). The NCR apparatus 500A (NCR-MT 520A) controls the NCR-Fwd 510A2 such that the NCR-Fwd 510A2 applies the second weight set to perform beamforming based on the NCR control signal.

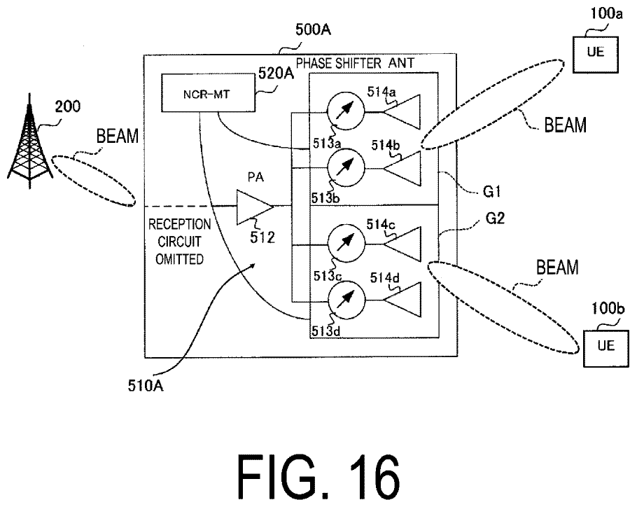

FIG. 16 is a diagram illustrating a second configuration example the NCR apparatus 500A for simultaneously forming multiple beams.

The NCR apparatus 500A simultaneously forms multiple beams when performing beamforming using multiple antennas (multiple antenna elements) included in the antenna 511a illustrated in FIG. 8. The multiple antennas correspond to an example of the multiple elements used for beamforming. For example, the NCR apparatus 500A simultaneously forms individual beams (independent beams) for the respective UEs 100a and 100b. Under such an assumption, the NCR-MT 520A groups the multiple antennas into multiple groups to perform beam control independent for each group.

In the example of FIG. 16, an illustration is omitted for a configuration of a reception system (reception circuit and the like) in the NCR apparatus 500A.

The NCR-Fwd 510A includes, as a configuration of a transmission system, a power amplifier (PA) 512, multiple phase shifters 513 (513a to 513d), and multiple antennas 514 (514a to 514d). The phase shifters 513 are provided in a one to-one correspondence with the antennas 514. The phase shifters 513 and the antennas 514 are part of the antenna 511a described above. Note that although an example is illustrated in which the number of antennas 514 is four, the number of antennas 514 may be four or more. Although an example is illustrated in which one PA 512 is provided, four PAs 512 may be provided, and these multiple PAs 512 may correspond to the antenna 514 on a one to-one basis. Note that in the illustrated example, a configuration of analog beamforming is illustrated, but digital beamforming by digital signal processing may be performed.

The PA 512 is a part of the RF circuit 511b describe above. A signal received by the reception circuit is input to the PA 512. The PA 512 amplifies the input signal (transmission signal) and outputs the amplified transmission signal to each of the phase shifters 513. Each of the phase shifters 513 adjusts a phase of the transmission signal by multiplying the transmission signal by the weight acquired by the directivity controller 511c described above, and outputs the transmission signal having the adjusted phase to the corresponding antenna 514. Each antenna 514 radiates the input transmission signal into space as a radio wave.

For the NCR apparatus 500A configured as described above, the NCR-MT 520A groups the multiple antennas 514 (and the multiple phase shifters 513) into multiple groups G (G1, G2) to perform beamforming control independent for each of the groups G. Note that the PA 512 may be individually provided for each of the groups G. Although an example is illustrated in which the number of groups G is two, the number of groups may be three or more. Such a group may be referred to as an antenna set. In this case, the group G1 may be an antenna set #1 and the group G2 may be an antenna set #2. The number of antennas 514 constituting each group may be non-uniform. For example, the number of antennas 514 constituting the group G1 may be two, and the number of antennas 514 constituting the group G2 may be three. While not being limited to the configuration in which the antennas 514 physically adjacent to each other are grouped, the antennas 514 that are not physically adjacent to each other may be grouped.

Note that the NCR-MT 520A may perform control to form one beam using all antennas 514 without performing such grouping. That is, the NCR-MT 520A may perform switching control of ON and OFF of grouping.

The first configuration example and the second configuration example described above may be combined and implemented. For example, the NCR apparatus 500A may include multiple NCR-Fwds 510A capable of simultaneously forming independent beams. The antennas 514 of each NCR-Fwd 510A may be grouped into multiple groups G capable of simultaneously forming independent beams.

### (1.10) Codebook Used in Relay Apparatus

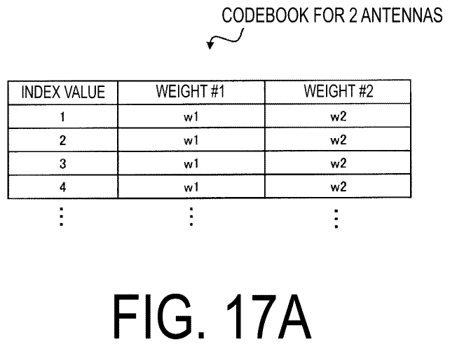

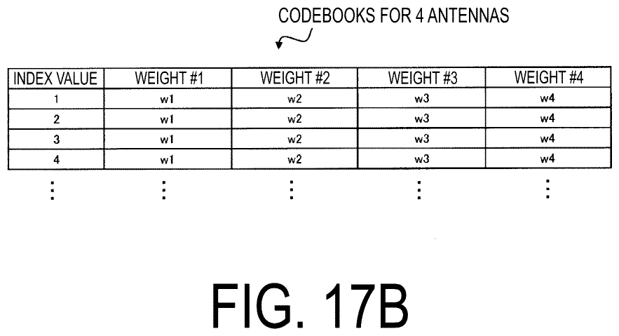

FIGS. 17A and 17B are diagrams illustrating an example of a codebook used in the NCR apparatus 500A according to the first embodiment.

The codebook illustrated in FIG. 17A is a codebook for two antennas. The codebook is a table in which a weight set (that is, a control value set) consisting of a weight #1 for an antenna #1 and a weight #2 for an antenna #2 is associated with an index value. On the other hand, the codebook illustrated in FIG. 17B is a codebook for four antennas. The codebook is a table in which a weight set (that is, a control value set) consisting of a weight #1 for an antenna #1, a weight #2 for an antenna #2, a weight #3 for an antenna #3, and a weight #4 for an antenna #4 is associated with an index value.

In this manner, the NCR apparatus 500A needs a codebook for each number of antennas used for beamforming (that is, each number of elements used for beamforming). However, for example, when grouping of the antennas 514 as described above is performed, the number of antennas used for beamforming may vary depending on the configuration. Therefore, a problem exists in that the codebook to be used by the NCR apparatus 500A is not uniquely determined.

In the embodiment, in the NCR apparatus 500A, one or more NCR-Fwds 510A that relay a radio signal from the gNB 200 to the UE 100 through beamforming include multiple antennas 514 (multiple elements) to each of which a weight (control value) for controlling a propagation state of the radio signal is applicable. The NCR-MT 520A that controls the NCR-Fwd 510A by performing wireless communication with the gNB 200 specifies a codebook based on the configuration from the gNB 200, the codebook defining a weight set (control value set) for each index value. In this way, the NCR-MT 520A specifying the codebook based on the configuration from the gNB 200 enables the NCR apparatus 500A to perform beamforming using an appropriate codebook.

In response to the NCR apparatus 500A (NCR-MT 520A) receiving the index value from the gNB 200, the NCR-MT 520A derives a weight set corresponding to the received index value based on the codebook. The NCR-MT 520A controls the NCR-Fwd 510A such that the NCR-Fwd 510A performs beamforming using the derived weight set.

### (1.10.1) First Operation Example for Codebook Used in Relay Apparatus

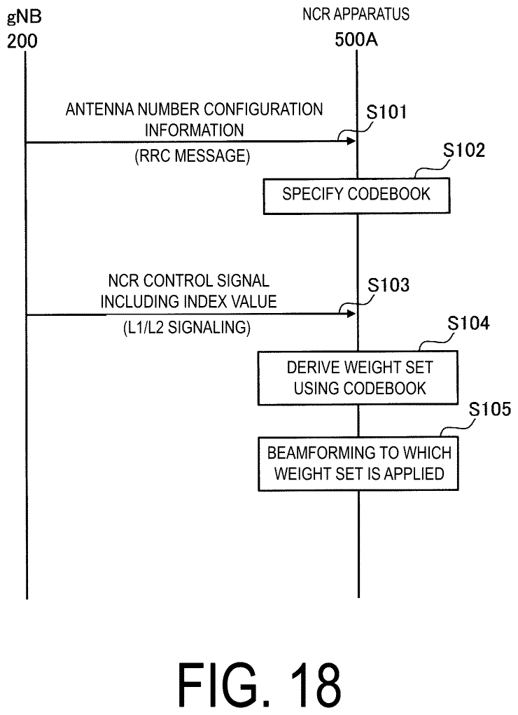

FIG. 18 is a diagram illustrating this operation example. In this operation example, the NCR-MT 520A receives configuration information to configure the number of antennas used for beamforming from the gNB 200. Such configuration information may be included in an RRC message (e.g., RRC Reconfiguration message) transmitted from the gNB 200 to the NCR-MT 520A. The NCR-MT 520A specifies a codebook corresponding to the number of antennas configured by the gNB 200 from among multiple codebooks individually defined in accordance with the number of antennas. That is, for the NCR apparatus 500A, the codebook to be used is implicitly designated by the configured number of antennas. As described above, in this operation example, the NCR apparatus 500A associates the number of antennas with the codebook in advance, and specifies the codebook to be used at the time when the configuration is performed from the gNB 200.

When the multiple antennas 514 are grouped into multiple groups G (see FIG. 16), the configuration information may indicate the number of antennas constituting each group G. The NCR apparatus 500A (NCR-MT 520A) may control the NCR-Fwd 510A such that the NCR-Fwd 510A performs beamforming for each group G using the codebook specified for each group G based on the number of antennas.

As illustrated in FIG. 18, in step S101, the gNB 200 configures the number of antennas for the NCR apparatus 500A (NCR-MT 520A). For example, the gNB 200 configures 4 antennas or 16 antennas per group G.

In step S102, the NCR apparatus 500A (NCR-MT 520A) specifies a codebook corresponding to the number of antennas configured in step S101. For example, when four antennas are configured in step S101, the NCR apparatus 500A (NCR-MT 520A) specifies a codebook for four antennas. When 16 antennas are configured in step S101, the NCR apparatus 500A (NCR-MT 520A) specifies a codebook for 16 antennas.

Note that candidate codebooks (codebooks for each number of antennas) may be defined in advance in technical specifications. As for the codebook, the gNB 200 may provide the candidate codebooks to the NCR apparatus 500A (NCR-MT 520A) in advance in an RRC message or the like.

In step S103, the gNB 200 transmits an NCR control signal including an index value indicating a weight set to the NCR apparatus 500A (NCR-MT 520A). The NCR apparatus 500A (NCR-MT 520A) receives the NCR control signal.

In step S104, the NCR apparatus 500A (NCR-MT 520A) acquires (derives) the weight set corresponding to the index value received in step S103 from the codebook specified in step S102.

In step S105, the NCR apparatus 500A (NCR-MT 520A) 5 controls the NCR-Fwd 510A such that the NCR-Fwd 510A applies the weight set acquired in step S104 to perform beamforming.

### (1.10.2) Second Operation Example for Codebook Used in Relay Apparatus

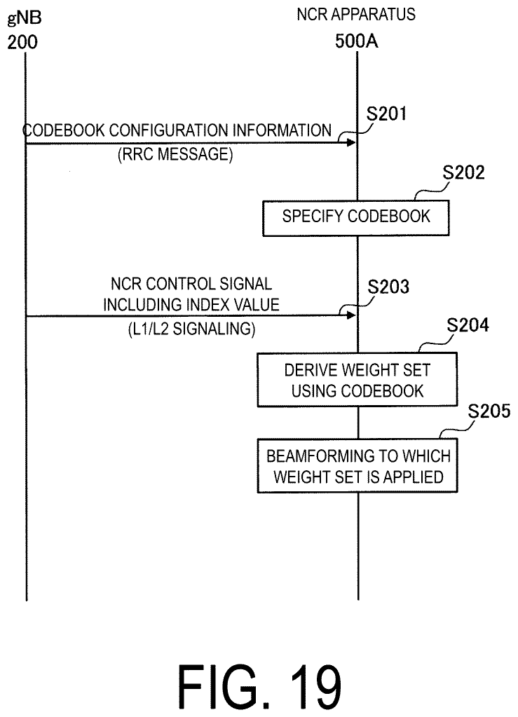

FIG. 19 is a diagram illustrating this operation example. In this operation example, the NCR-MT 520A of the NCR apparatus 500A including multiple NCR-Fwds 510A (see FIG. 15) may receive, from the gNB 200, configuration information to individually configure a codebook for each of the multiple NCR-Fwds 510A. Such configuration information may be included in an RRC message (e.g., RRC Reconfiguration message) transmitted from the gNB 200 to the NCR-MT 520A. The NCR apparatus 500A (NCR-MT 520A) may specify the codebook for each NCR-Fwd 510A based on the configuration information.

When the multiple antennas 514 are grouped into multiple groups G (see FIG. 16), the NCR apparatus 500A (NCR-MT 520A) may receive the configuration information to individually configure a codebook for each of the multiple groups G from the gNB 200. Such configuration information may be included in an RRC message (e.g., RRC Reconfiguration message) transmitted from the gNB 200 to the NCR-MT 520A. The NCR apparatus 500A (NCR-MT 520A) may specify the codebook for each group G based on the configuration information.

As described above, in this operation example, the codebook is explicitly configured for each NCR-Fwd 510A and/or for each group G by the gNB 200. This enables the NCR apparatus 500A to perform beamforming using an appropriate codebook.

As illustrated in FIG. 19, in step S201, the gNB 200 configures an identifier of the codebook to be applied for the NCR apparatus 500A (NCR-MT 520A). For example, the gNB 200 configures a set of the identifier of the codebook and the identifier of the NCR-Fwd 510A and/or an identifier of the group G for the NCR apparatus 500A (NCR-MT 520A). For example, an NCR-Fwd #1 with a codebook #A, an antenna group #1 of an NCR-Fwd #2 with a codebook #B, and the like are configured.

Note that the candidate codebooks may be defined in advance in technical specifications. As for the codebook, the gNB 200 may provide the candidate codebooks to the NCR apparatus 500A (NCR-MT 520A) in advance in an RRC message or the like.

In step S202, the NCR apparatus 500A (NCR-MT 520A) specifies the codebook configured in step S201.

The operations in steps S203 to S205 are the same as and/or similar to those of the first operation example described above.

### (1.10.3) Third Operation Example for Codebook Used in Relay Apparatus

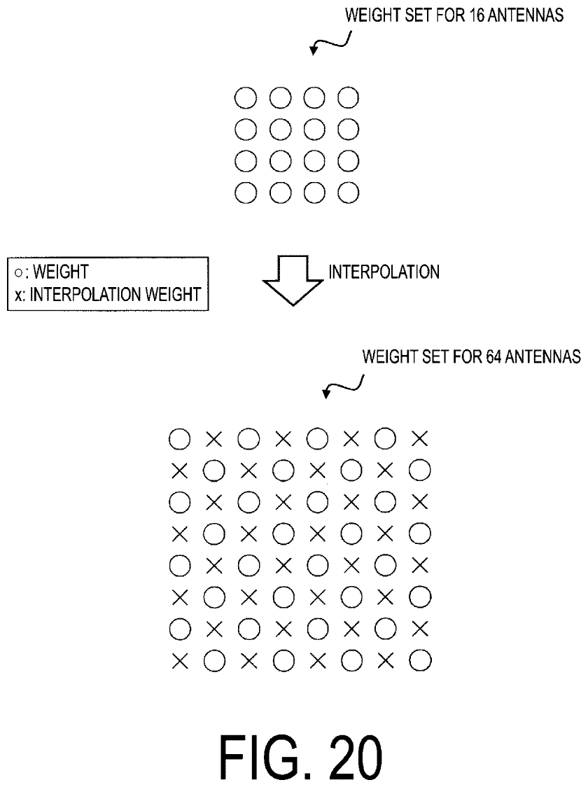

FIG. 20 is a diagram illustrating this operation example. This operation example may be implemented in combination with the first operation example or the second operation example described above. In this operation example, when the number of weights in the weight set in the codebook is smaller than the number of antennas used for beamforming, the NCR apparatus 500A (NCR-MT 520A) derives a remaining number of weights by interpolating between the weights in the weight set. That is, the codebook defines only the representative weight, and the remaining portion is interpolated. This can suppress an increase in the size of the codebook.

FIG. 20A illustrates an example in which the multiple antennas 514 includes 4×4 horizontally and vertically, i.e., 16 antennas. The NCR apparatus 500A (NCR-MT 520A) holds a codebook assuming such an antenna configuration as a basic codebook. The codebook is a table in which a weight set consisting of 16 weights corresponding to 16 antennas is associated with an index value. The codebook may be defined in advance in technical specifications. The gNB 200 may provide the codebook to the NCR apparatus 500A (NCR-MT 520A) in advance in an RRC message or the like.

Under such an assumption, the gNB 200 configures the number of antennas larger than the number of antennas supported by the codebook for the NCR apparatus 500A (NCR-MT 520A). For example, the NCR apparatus 500A (NCR-MT 520A) having a codebook for 16 antennas is configured with the number of antennas of 64. As illustrated in FIG. 20B, the NCR apparatus 500A (NCR-MT 520A) calculates the weight for the antenna which is not defined by the codebook by interpolation. The interpolation may be linear interpolation.

In the example of FIG. 20B, a weight of an antenna indicated by “x” is not defined in the codebook, but weights of upper, lower, left, and right antennas of the antenna indicated by “x” are defined in the codebook. Therefore, the NCR apparatus 500A (NCR-MT 520A) may calculate the weight of the antenna indicated by “x” by, for example, interpolating between (for example, averaging of) the weights of the upper, lower, left, and right antennas. Thus, the codebook for 16 antennas can be extended to 64 antennas. The NCR apparatus 500A (NCR-MT 520A) controls beamforming by using the codebook for 64 antennas.

### (1.11) Example of Multi-Beam Operation of Relay Apparatus

As described above, the NCR apparatus 500A can form multiple beams by multiple NCR-Fwds 510A as illustrated in FIG. 15 and/or multiple antenna sets (multiple groups G) as illustrated in FIG. 16.

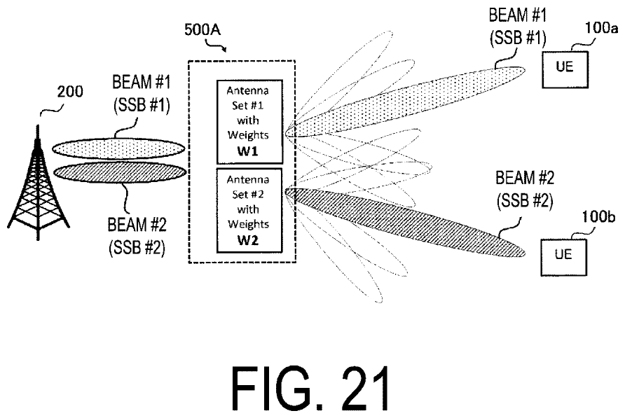

FIG. 21 illustrates an example in which the NCR apparatus 500A simultaneously forms two beams (beams #1 and #2) by using two antenna sets. Here, the gNB 200 forms the beam #1 transmitting an SSB #1 and the beam #2 transmitting an SSB #2, and the NCR apparatus 500A relays the beam #1 (SSB #1) and the beam #2 (SSB #2). Note that in the following description of the embodiments, the beam #1 may be interpreted as the SSB #1, and the beam #2 may be interpreted as the SSB #2.

The NCR apparatus 500A has two antenna sets (Antenna Sets) #1 and #2. A weight set W1 is applied to the antenna set #1, and a weight set W2 is applied to the antenna set #2. The antenna set #1 forms the beam #1 to which the weight set W1 is applied, and the antenna set #2 forms the beam #1 to which the weight set W2 is applied.

The UE 100a has selected the beam #1. For example, the UE 100a has completed access to the gNB 200 at a PRACH occasion associated with the beam #1 (SSB #1). On the other hand, the UE 100b has selected the beam #2. For example, the UE 100b has completed access to the gNB 200 at a PRACH occasion associated with the beam #2 (SSB #2).

The gNB 200 schedules the UE 100a and the UE 100b in different resource blocks of the same time slot. The NCR apparatus 500A forms beams with the weight set W1 of the beam #1 for the UE 100a and the weight set W2 of the beam #2 for the UE 100b in the same time slot. In such a method, two antenna sets (or two NCR-Fwds 510A) are required to form two beams (beams #1 and #2).

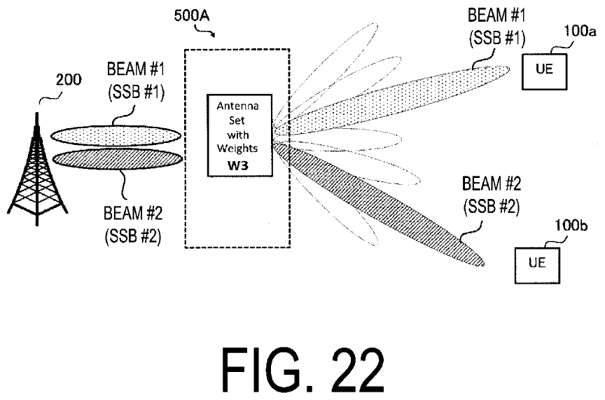

As illustrated in FIG. 22, the NCR apparatus 500A (NCR-MT 520A) specifies a common weight set W3 derived from multiple weight sets including the weight set W1 for forming beam #1 and the weight set W2 for forming the beam #2 having a beam direction different from that of the beam #1. For example, the NCR apparatus 500A (NCR-MT 520A) controls the NCR-Fwd 510A such that the NCR-Fwd 510A forms both the beam #1 and the beam #2 by the multiple antennas 514 using the common weight set W3. Accordingly, two beams (beams #1 and #2) can be efficiently formed by one antenna set (or one NCR-Fwd 510A) using the common weight set W3.

### (1.11.1) First Operation Example of Multi-Beam Operation of Relay Apparatus

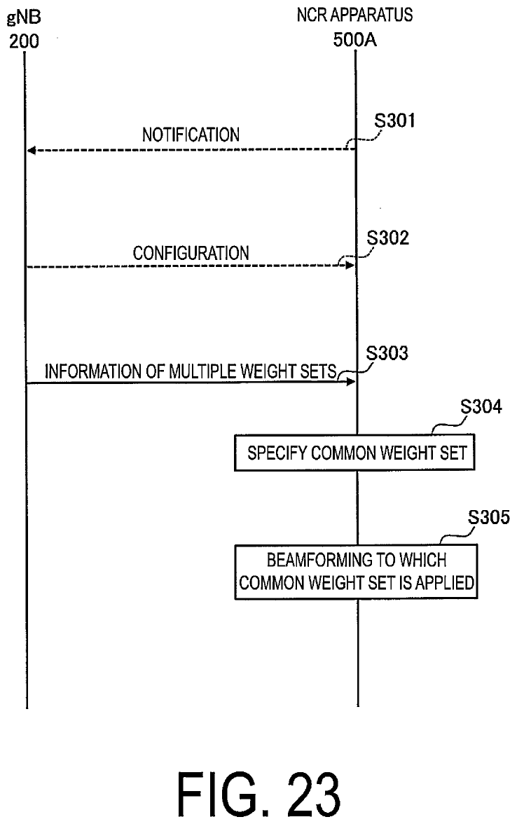

FIG. 23 is a diagram illustrating this operation example. In this operation example, the NCR apparatus 500A (NCR-MT 520A) acquires the multiple weight sets (W1, W2) from the gNB 200, and specifies the common weight set W3 from the acquired multiple weight sets. To be more specific, the gNB 200 notifies the NCR apparatus 500A (NCR-MT 520A) of multiple weight sets, and the NCR apparatus 500A (NCR-MT 520A) specifies and applies the common weight set W3 on which the multiple weight sets are cumulated.

As illustrated in FIG. 23, in step S301, the NCR apparatus 500A (NCR-MT 520A) may transmit a notification (for example, the above-described NCR capability information) including information on simultaneous beamforming capability (for example, the upper limit number of simultaneous beams) of the NCR apparatus 500A (NCR-MT 520A) to the gNB 200.

In step S302, the gNB 200 may configure the number or upper limit number of simultaneous beams for the NCR apparatus 500A (NCR-MT 520A). Note that a message size of an NCR control signal may be determined based on the configured number of beams. For example, when four beams are configured, the message size is such that control of the four beams can be performed simultaneously.

In step S303, the gNB 200 notifies the NCR apparatus 500A (NCR-MT 520A) of the multiple weight sets. For example, the gNB 200 notifies the NCR apparatus 500A (NCR-MT 520A) of the weight set #1 of the beam #1 and the weight set #2 of the beam #2. Here, the gNB 200 may transmit the weight set #1 and the weight set #2 as they are. The gNB 200 may transmit an index value of each of the weight set #1 and the weight set #2. The transmission may be performed by way of the NCR control signal described above.

In step S304, the NCR apparatus 500A (NCR-MT 520A) specifies the common weight set W3 for multi-beamforming from the multiple weight sets transmitted via the notification in step S303. For example, the NCR apparatus 500A (NCR-MT 520A) may hold in advance a table that defines the common weight set W3 for each combination of the index values of the weight set #1 and the weight set #2, and specify the common weight set W3 using the table. The NCR apparatus 500A (NCR-MT 520A) may specify the common weight set W3 by estimating the direction of the beam (main lobe) of each weight set and calculating the weight set of which the beam is directed in both directions.

In step S305, the NCR apparatus 500A (NCR-MT 520A) controls the NCR-Fwd 510A such that the NCR-Fwd 510A performs beamforming to which the common weight set W3 specified in step S304 is applied. Accordingly, the NCR-Fwd 510A forms multiple beams, for example, beams in a beam #1 direction and a beam #2 direction.

### (1.11.2) Second Operation Example for Multi-Beam Operation of Relay Apparatus

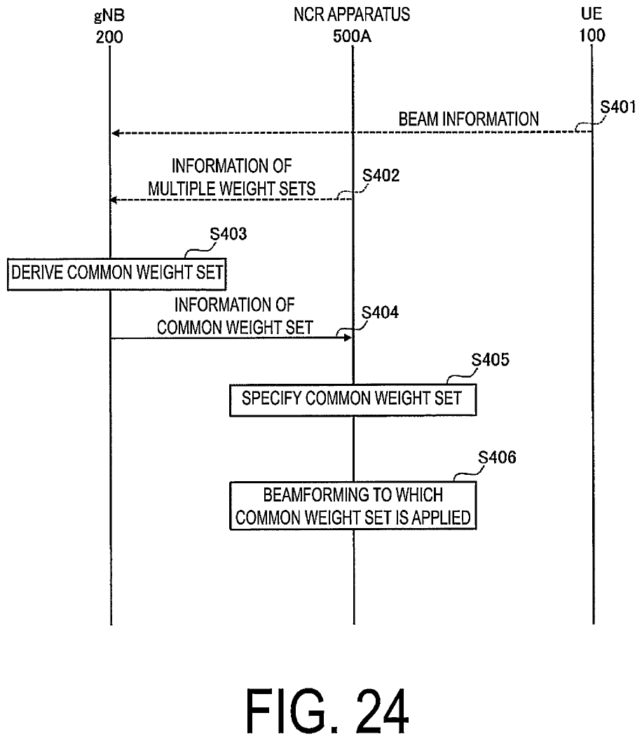

FIG. 24 is a diagram illustrating this operation example. In the above operation example, the common weight set W3 is derived by the NCR apparatus 500A (NCR-MT 520A), but in this operation example, the common weight set W3 is derived by the gNB 200. For example, in this operation example, the NCR apparatus 500A (NCR-MT 520A) notifies the gNB 200 of multiple weight sets (W1, W2). The gNB 200 provides the common weight set W3 derived based on the multiple weight sets to the NCR apparatus 500A (NCR-MT 520A). The NCR apparatus 500A (NCR-MT 520A) specifies the common weight set W3 by acquiring the common weight set W3 from the gNB 200.

In this operation example, the UE 100 may transmit beam information indicating one or more beams satisfying a predetermined quality criterion to the gNB 200. For example, the UE 100 may transmit information indicating a beam other than the highest-quality beam to the gNB 200. The gNB 200 may provide the common weight set W3 derived based on the beam information from the UE 100 to the NCR apparatus 500A (NCR-MT 520A).

As illustrated in FIG. 24, in step S401, the UE 100 may report to the gNB 200 a receivable beam other than the selected beam. For example, the UE 100a illustrated in FIG. 21 selects the beam #1 (highest-quality beam), but, if possible to receive a beam having qualities equal to or lower than the second rank including the beam #2, transmits information (for example, SSB index) of each beam having qualities equal to or lower than the second rank to the gNB 200. The UE 100 may transmit radio quality information (for example, RSRP) for each beam in addition to the SSB index to the gNB 200. The beam information in step S401 may be included in an RRC message or a MAC CE transmitted from the UE 100 to the gNB 200.

In step S402, the NCR apparatus 500A (NCR-MT 520A) may inform the gNB 200 of the multiple weight sets. For example, the NCR apparatus 500A (NCR-MT 520A) notifies the NCR apparatus 500A (NCR-MT 520A) of the index values of the weight set #1 of the beam #1 and the weight set #2 of the beam #2. The multiple weight sets may be weight sets configured by the gNB 200. The multiple weight sets may be weight sets determined by the NCR apparatus 500A (NCR-MT 520A) based on the configuration from the gNB 200. The NCR apparatus 500A (NCR-MT 520A) may notify the gNB 200 of a weight set of each beam (main lobe) to which a side lobe is directed. The weight set may be a weight set of which the side lobe is directed in the beam #1 direction or the beam #2 direction but the main lobe is directed to another direction.

In step S403, the gNB 200 derives the common weight set W3 based on the information notified in step S401 and/or step S402. For example, the gNB 200 may derive a weight set with which the UE 100a and the UE 100b can communicate with each other as the common weight set W3 based on the information in S401. The gNB 200 may hold in advance a table that defines the common weight set W3 for each combination of the index values of the weight set #1 and the weight set #2, and derive the common weight set W3 using the table.

In step S404, the gNB 200 notifies the NCR apparatus 500A (NCR-MT 520A) of the common weight set W3 derived in step S403.

In step S405, the NCR apparatus 500A (NCR-MT 520A) controls the NCR-Fwd 510A such that the NCR-Fwd 510A performs beamforming to which the common weight set W3 specified in step S404 is applied. Accordingly, the NCR-Fwd 510A forms multiple beams, for example, beams in a beam #1 direction and a beam #2 direction.

### (2) Second Embodiment

With respect to a second embodiment, differences from the first embodiment described above are mainly described. The overview of a mobile communication system 1 and the configuration of a gNB 200 according to the second embodiment each are the same as and/or similar to that of the first embodiment described above.

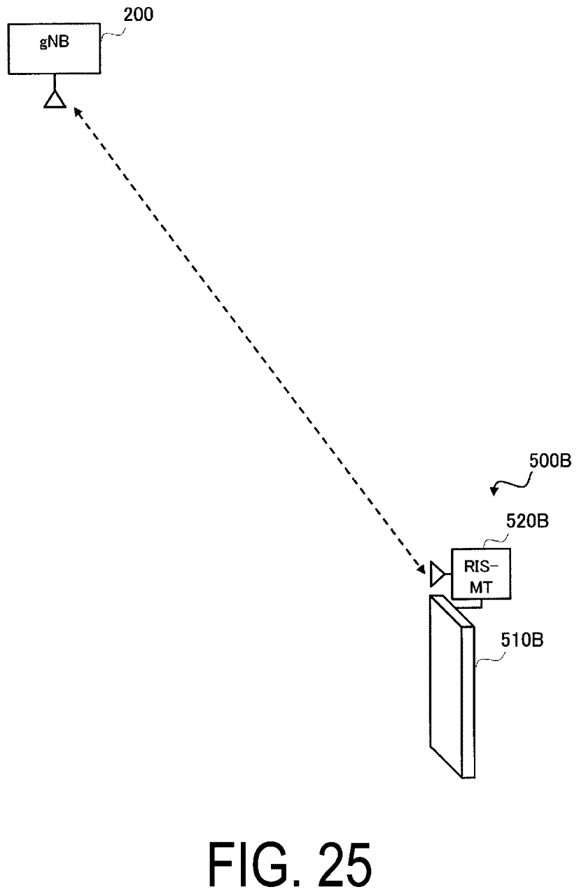

As illustrated in FIG. 25, a relay apparatus according to the second embodiment is a Reconfigurable Intelligent Surface (RIS) apparatus 500B configured to change a propagation direction of an incident radio wave (radio signal) by reflection or refraction. The “NCR” in the first and second embodiments described above may be interpreted as the “RIS”.

The RIS is a type of a repeater (hereinafter, also referred to as a “RIS-Fwd”) capable of performing beamforming (directivity control) in the same and/or similar way as the NCR by changing the characteristics of metamaterials. The RIS may be able to change a range (distance) of a beam by controlling a reflection direction and/or a refraction direction of each unit element (also referred to as a “structure”). For example, the RIS may have a configuration capable of controlling the reflection direction and/or refraction direction of each unit element, and focusing on a near UE (directing a beam) or focusing on a far UE (directing a beam). The unit element (structure) is an example of the element to which a control value for controlling a propagation state of a radio signal is applicable.

The RIS apparatus 500B includes a new UE (hereinafter referred to as “RIS-MT”) 520B which is a control terminal for controlling the RIS-Fwd 510B. The RIS-MT 520B controls the RIS-Fwd 510B in cooperation with the gNB 200 by establishing a radio connection to the gNB 200 and performing wireless communication with the gNB 200. The RIS-Fwd 510B may be a reflective RIS. Such a RIS-Fwd 510B reflects an incident radio wave to change the propagation direction of the radio wave. Here, a reflection angle of the radio wave can be variably configured. The RIS-Fwd 510B reflects a radio wave incident from the gNB 200 toward the UE 100. The RIS-Fwd 510B may be a transmissive RIS. Such a RIS-Fwd 510B refracts an incident radio wave to change the propagation direction of the radio wave. Here, a refraction angle of the radio wave can be variably configured.

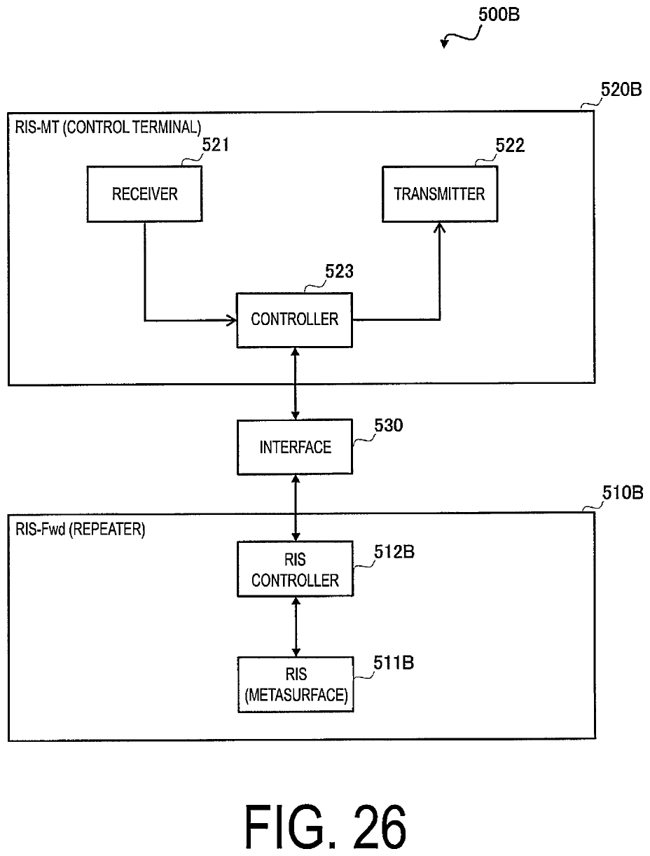

FIG. 26 is a diagram illustrating a configuration example of the RIS-Fwd (repeater) 510B and the RIS-MT (control terminal) 520B according to the second embodiment. The RIS-MT 520B includes a receiver 521, a transmitter 522, and a controller 523. Such a configuration is the same as and/or similar to that in the first embodiment described above. The RIS-Fwd 510B includes a RIS 511B and a RIS controller 512B. The RIS 511B is a metasurface configured using metamaterials. For example, the RIS 511B is configured by installing, in an array form, structures being very small with respect to a wavelength of a radio wave, and a direction and/or a beam shape of a reflected wave is arbitrarily designed by forming the structures in different shapes depending on an installation place. The RIS 511B may be a transparent dynamic metasurface. The RIS 511B may be configured to include a transparent glass substrate stacked on a metasurface substrate on which a large number of small structures are regularly arranged and which is made transparent, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B according to a RIS control signal from the controller 523 in the RIS-MT 520B. The RIS controller 512B may include at least one processor and at least one actuator. The processor interprets a RIS control signal from the controller 523 in the RIS-MT 520B to drive the actuator according to the RIS control signal.

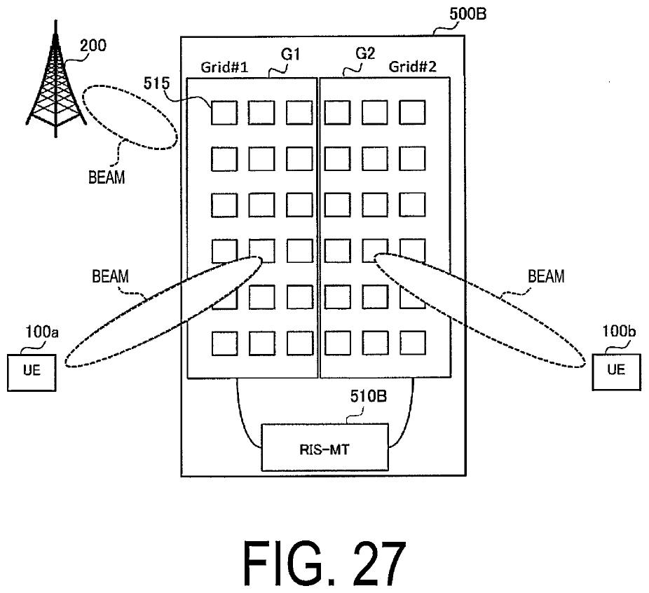

FIG. 27 is a diagram for describing a multi-beam operation of the RIS apparatus 500B. The RIS apparatus 500B includes multiple structures 515 that are periodically arranged in the horizontal and vertical directions. The RIS apparatus 500B realizes electromagnetic characteristics which do not exist in nature by the periodic arrangement of the structures 515. By adjusting the shape and/or the electromagnetic characteristics of the structure 515, desired characteristics (for example, bending radio waves in an arbitrary direction) are obtained.

For the RIS apparatus 500B configured as described above, the RIS-MT 520B may group the multiple structures 515 into multiple groups G (G1, G2) to perform beam control independent for each of the groups. In the illustrated example, although the number of groups G is two, the number of groups G may be three or more. Such a group may be referred to as a “grid”. The number of structures 515 constituting each group G may be non-uniform. Note that although the structures 515 that are physically adjacent to each other are grouped, the structures 515 that are not physically adjacent to each other may be grouped, for example, alternately grouped every other structure.

### (3) Another Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 (NCR-MT 520A, RIS-MT 520B) or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplementary Note

Features relating to the embodiments described above are described below as supplements.

### Supplementary Note 1

A communication method used in a mobile communication system including a relay apparatus configured to be controlled by a network, the communication method including:
relaying, by one or more repeaters included in the relay apparatus, a radio signal from a base station to a user equipment through beamforming; and
controlling, by a control terminal included in the relay apparatus, the repeater by performing wireless communication with the base station,
wherein the one or more repeaters include multiple elements to which control values for controlling a propagation state of a radio signal are applicable respectively, and
the controlling includes specifying a codebook based on a configuration from the base station, the codebook defining a control value set as a set of the control values for each index value.

### Supplementary Note 2

The communication method according to supplementary note 1, wherein
the controlling further includes
in response to the control terminal receiving the index value from the base station, deriving the control value set corresponding to the received index value based on the codebook, and
controlling the one or more repeaters to perform the beamforming using the derived control value set.

### Supplementary Note 3

The communication method according to supplementary note 1 or 2, wherein the specifying includes
receiving, by the control terminal, configuration information to configure the number of elements used for the beamforming from the base station, and
specifying the codebook corresponding to the configured number of elements from among a plurality of the codebooks individually defined in accordance with the number of elements.

### Supplementary Note 4

The communication method according to supplementary note 3, wherein
when the multiple elements are grouped into multiple groups, the configuration information indicates the number of elements constituting each group, and
the controlling includes controlling the one or more repeaters to perform the beamforming for each of the multiple groups using the specified codebook.

### Supplementary Note 5

The communication method according to any one of supplementary notes 1 to 4, wherein the specifying includes
receiving, by the control terminal, configuration information to individually configure the codebook for each of the multiple repeaters from the base station, and
specifying the codebook for each of the repeaters based on the configuration information.

### Supplementary Note 6

The communication method according to any one of supplementary notes 1 to 5, wherein
when the multiple elements are grouped into multiple groups, the specifying includes
receiving configuration information to individually configure the codebook for each of the multiple groups from the base station, and
specifying the codebook for each of the multiple groups based on the configuration information.

### Supplementary Note 7

The communication method according to any one of supplementary notes 1 to 6, wherein
when the number of the control values in the control value set is smaller than the number of elements used for the beamforming, the controlling includes deriving a remaining number of control values by interpolating between the control values in the control value set.

### Supplementary Note 8

A communication method used in a mobile communication system comprising a relay apparatus configured to be controlled by a network, the communication method including:
relaying, by one or more repeaters included in the relay apparatus, a radio signal from a base station to a user equipment through beamforming; and
controlling, by a control terminal included in the relay apparatus, the repeater by performing wireless communication with the base station,
wherein the one or more repeaters include multiple elements to which control values for controlling a propagation state of a radio signal are applicable respectively, and
the controlling includes specifying a common control value set derived from multiple control value sets including a first control value set to form a first beam and a second control value set to form a second beam having a beam direction different from a beam direction of the first beam.

### Supplementary Note 9

The communication method according to supplementary note 8, wherein
the controlling further including controlling the one or more repeaters to form both the first beam and the second beam with the multiple elements by using the common control value set.

### Supplementary Note 10

The communication method according to supplementary note 8 or 9, wherein
the specifying includes
acquiring, by the control terminal, the multiple control value sets from the base station, and
specifying the common control value set from the multiple control value sets acquired.

### Supplementary Note 11

The communication method according to any one of supplementary notes 8 to 10, wherein
the specifying includes
notifying, by the control terminal, the base station of the multiple control value sets, and
specifying the common control value set by acquiring, from the base station, the common control value set derived by the base station based on the multiple control value sets.

### Supplementary Note 12

The communication method according to any one of supplementary notes 8 to 11, further including:
transmitting, at a user equipment, beam information indicating one or more beams satisfying a predetermined quality criterion from the user equipment to the base station,
wherein the specifying includes specifying the common control value set by acquiring, by the control terminal from the base station, the common control value set derived by the base station based on the beam information.

### Supplementary Note 13

The communication method according to supplementary note 12, wherein
the transmitting the beam information includes transmitting information indicating a beam other than a highest-quality beam from the user equipment to the base station.

### (5) Supplementary Note

### Introduction

RAN #94e has agreed on a new study item for the network-controlled repeater (NCR). The purposes of this study are as follows.

Side control information required for the network-controlled repeater is studied and defined as follows (including the assumption of maximum transmission power):
Beamforming information;
Timing information for aligning transmission and reception boundaries of the network-controlled repeater;
Information relating to UL-DL TDD configuration;
   ON-OFF information for efficient interference management and energy efficiency enhancement;
Power control information for efficient interference management (as a second priority).

The L1/L2 signaling (including its configuration) for transmitting the side control information is studied and defined.

For the management of the network-controlled repeater, the following points are studied.
Identification and authorization of the network-controlled repeater.

Note 2: Adjustment with the SA3 may be necessary.

This supplementary note provides a discussion of RAN2 initial problems with respect to the NCR.

### DISCUSSION

### NCR Model

According to the SID, scenarios and assumptions are described as follows.

The study of a NR network-controlled repeater is intended to focus on the following scenarios and assumptions.
A network-controlled repeater is an in-band RF-repeater used to extend a network coverage in the FR1 and FR2 bands. A study is underway that deployment of the FR2 may be prioritized in both outdoor to indoor O2I scenarios.
Limiting to single-hop stationary network-controlled repeater.
The network-controlled repeater is transparent to the UE.
The network-controlled repeater can simultaneously maintain the link with the gNB and the link with the UE.

Note 1: Cost efficiency is an important consideration for the network-controlled repeater.

RAN1 #109e has agreed on the model of NCR as follows.

### Agreements:

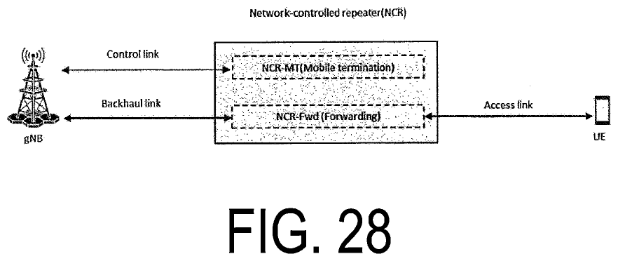

A model of the TR38.867 network-controlled repeater is illustrated in FIG. 28 and below.
The NCR-MT is defined as a functional entity that communicates with the gNB via a control link (C-link). This enables information exchange (e.g., side control information). The C-link is based on an NR Uu interface.

Note: The side control information is at least for control of the NCR-FW.
The NCR-Fwd is defined as a functional entity that amplifies and transfers the received UL/DL RF signals between gNB and UE via the backhaul link and the access link. The operation of the NCR-Fwd is controlled according to the side control information received from the gNB.

According to the above description, since the NCR-Fwd is an in-band RF-repeater, no impact on the RAN2 would be present.

Observation 1: the NCR-Fwd is an RF-repeater and is out of range of the RAN2.

On the other hand, the NCR-MT maintains a control link with the gNB and communicates the side control information. The NCR-MT may be considered as a special UE type similar to the IAB-MT. Specifically, it is natural to consider that support of protocols such as NAS, RRC, PDCP, RLC, MAC, and PHY is required. As a starting point, the IAB-MT is considered to be a good reference for modeling the NCR-MT. However, the BAP sub-layer is clearly not needed for the NCR-MT because of the assumption of “single-hop stationary network-controlled repeater only”, and control link coverage enhancement should be done by other means, such as using the FR1 or using the RF-repeaters.

Proposal 1: as a starting point, the RAN2 should consider the IAB-MT as the reference for the NCR-MT model, and the BAP sublayer is not supported in the NCR-MT.

The IAB-MT can transmit and receive its own traffic, such as OAM traffic. The same principle applies to the NCR-MT as the NCR may implement the OAM function. Therefore, the NCR-MT needs to support not only an SRB (side control information, RRC configuration, NAS connection, or the like) but also a DRB (own traffic, or the like) and the establishment of the DRB may be optional.

Proposal 2: it should be agreed that NCR-MT supports both the SRB and the DRB.

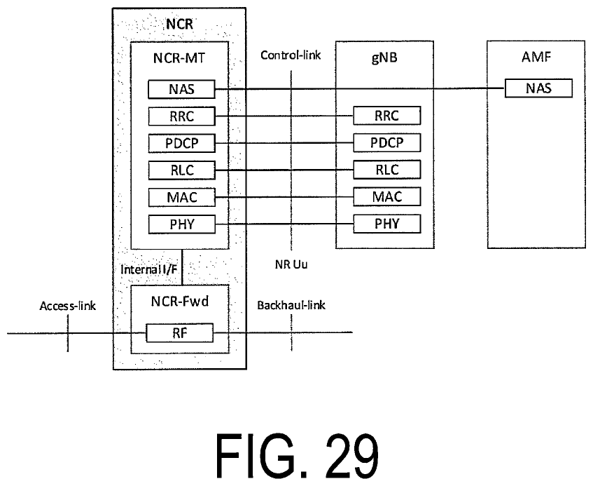

As illustrated in FIG. 29, the indication of the gNB (for example, side control information) is considered to be used by the NCR-MT to control (for example, beamforming, ON/OFF control, power control, and the like) of the NCR-Fwd via the internal interface, and whether such internal interface is designated is not a matter.

Observation 2: the NCR-MT receives an indication from the gNB (e.g., through the side control information) and controls the NCR-Fwd accordingly.

Aspects related to NCR management Identification, Authentication, Access Control According to the SID, the RAN2 is responsible for studying management aspects.

The following aspects related to the management of the network-controlled repeaters are studied.
Identification and authentication of the network-controlled repeaters.

Note 2: Adjustment with the SA3 may be necessary.

For the IAB-MT considered as a reference as in Proposal 1, the same access control mechanism may be applicable to the NCR-MT since the NCR is considered as a network node.
The gNB provides a SIB indication to allow NCR-MT access. This is like the IAB-Support IE in the SIB1.
The NCR-MT ignores Cell Barred IE and Intra-Freq Reselection IE of the MIB.
The NCR-MT ignores the following IEs related to reserved cells:
Cell Reserved For Future Use IE
Cell Reserved For Other Use IE (for cell barring decision)
Cell Reserved For Operator Use IE (when the NCR-MT supports NPN)
The NCR-MT transmits the NCR indication upon RRC setup completion, such as the IAB Node Indication IE.

Proposal 3: when the NCR is considered as a network node, the RAN2 should agree to reuse the access control mechanism of the IAB-MT. That is, the gNB provides the SIB indication and the NCR-MT ignores IEs related to the cell barring and the cell reservation.

When the NCR-MT is considered similar to the IAB-MT from the point of view of the RAN2, the RAN2 may assume that the higher layer mechanism of the IAB-MT is also reused for the NCR-MT. For example, it may be re-used for authentication.

Observation 3: the RAN2 can assume that the higher layer mechanisms of IAB-MT are also reused for the NCR-MT. For example, it is reuse in terms of authentication.

### NCR Capability Signal

Another problem with the management is how the gNB recognizes the functions of the NCR-Fwd such as operating frequency, the number and resolution of beamformings, and output power and dynamic range since the NCR-Fwd is an RF repeater, that is, no protocol support is provided. The NCR-MT notifying the gNB of the capabilities of the connected NCR-Fwd in addition to its own (i.e., NCR-MT) capabilities is a very simple matter.

Proposal 4: the RAN2 should agree that the NCR-MT notifies the gNB of the capabilities of the NCR-Fwd. The capabilities to be reported are required to be further studied.

### Multi-Beam NCR

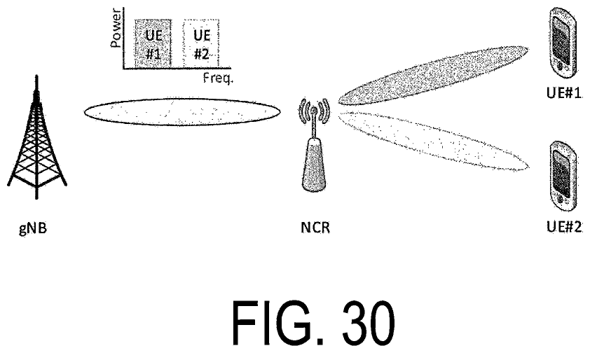

As illustrated in FIG. 30, whether the NCR can process multiple beams is also worth studying. Thus, improved spectral efficiency, enhanced coverage, and scheduling flexibility for multiple UEs are expected.

A simple RF repeater has no resource block selectivity and amplifies and transfers all signals within the system bandwidth with a single weight. On the other hand, some advanced RF repeaters may manage multiple beams for multiple UEs. Therefore, it is important that Rel-18 NCR supports such advanced RF-repeater implementations.

Proposal 5: the RAN2 should agree to manage the NCR where the gNB can process multiple beams simultaneously for different UEs.

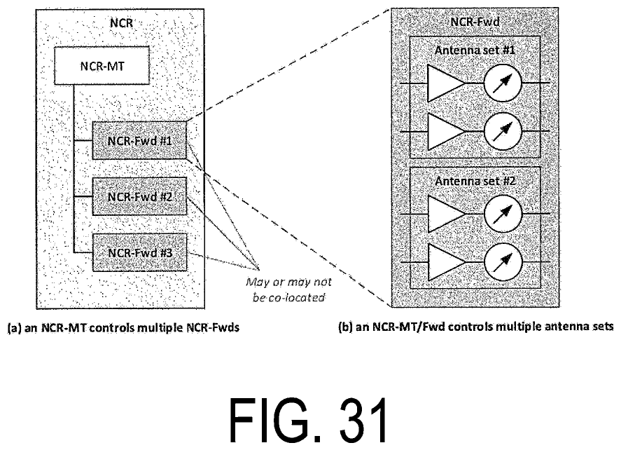

When multi-beam NCR is supported, from a RAN2 point of view, a discussion may arise as to whether one NCR node (or one NCR-MT) can support multiple NCR-Fwds. Whether one NCR-Fwd can control multiple “antenna sets” may also be additionally considered. These options are illustrated in FIG. 31.

Multiple NCR-Fwds or multiple antenna sets can process different beams for different UEs using different resource blocks within the same slot (as illustrated in FIG. 30). For multiple NCR-Fwds, the NCR needs to simultaneously process different weights indicated by the gNB for each NCR-Fwd.

As another possible scenario, the NCR may be controlled by multiple gNBs. For example, it is when the NCR is deployed at the cell edge. In this case, multiple NCR-Fwds are needed to process different beams for different access links belonging to different gNBs.

These cases may affect the management of NCRs and the design of the side control information. Therefore, the RAN2 needs to discuss a management model to allow various implementations of multi-beam NCR.

Note: the RAN1 determines whether multiple NCR-Fwds are co-located (e.g., for spatial diversity gain). Even when multiple Fwds are not co-located, the RAN1 should assume that the control link and the backhaul link share the same radio channel conditions. This is suggested by the decision at RAN #96.

Proposal 6: the RAN2 should discuss a management model of repeaters with multiple beams. For example, study whether one NCR-MT can control multiple NCR-Fwds, or whether one NCR-Fwd can support multiple antenna sets, and the like.

### Side Control Information

The RAN1 discusses the general concept and functions of the side control information, such as beam information, TDD UL/DL configuration, timing of DL reception and UL transmission, and ON-OFF information. From a RAN2 point of view, it is assumed that dynamic and semi-static controls may be indicated by DCI and MAC CE (or a combination thereof), respectively. Furthermore, static configuration should be made by RRC. For the detailed design of the side control information, the RAN2 needs to wait for the progress of the RAN1.

Observation 4: the side control information may need to extend DCI, MAC CE, and/or RRC signaling. The RAN2 needs to wait for further development of the RAN1.

### Assumption on Deployment

Although multiple frequencies support was discussed in RAN #96, the operating frequency of the control link was determined to be limited similarly to the backhaul link. RAN chairman: the RAN1 studies will focus on in-band only.

A procedure of the control link may be intended to be simplified by exploiting the same channel conditions as the backhaul link.

Observation 5: when the control link and the backhaul link are operating at the same frequency, the radio channel conditions are the same.

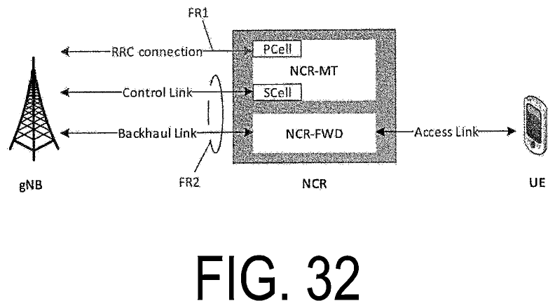

On the other hand, it is worth studying whether the NCR-MT can support carrier aggregation (CA) and dual connectivity (DC). For example, as illustrated in FIG. 32, the NCR-MT may configure the SCell (for side control information) in the FR2 at the same frequencies as the PCell (for RRC connection) in the FR1.

The NCR-MT CA/DC configuration is considered to not violate the RAN plenary decision as long as the SCell for the control link is operating at the same frequency as the NCR-Fwd for the backhaul link. Furthermore, a robust RRC connection in the FR1/PCell provides various advantages considering that the NCR is a network node. This is very similar to the CP/UP split configuration specified in the IAB.

Proposal 7: the RAN2 should study the possibility that the NCR-MT is configured with carrier aggregation (CA) or dual connectivity (DC). At least one SCell should be configured to operate at the same frequency as the NCR-Fwd.

### REFERENCE SIGNS

1: Mobile communication system
100: UE
200: gNB
210: Transmitter
220: Receiver
230: Controller
240: Backhaul communicator
500A: NCR apparatus
500B: RIS apparatus
511A: Radio unit
511a: Antenna
511b: RF circuit
511c: Directivity controller
512A: NCR controller
512B: RIS controller
513: Phase shifter
514: Antenna
515: Structure
521: Receiver
522: Transmitter
523: Controller
530: Interface

1. A communication method used in a mobile communication system comprising a relay apparatus configured to be controlled by a network, the communication method comprising:
relaying, by one or more repeaters comprised in the relay apparatus, a radio signal from a base station to a user equipment through beamforming; and
controlling, by a control terminal comprised in the relay apparatus, the repeater by performing wireless communication with the base station,
wherein the one or more repeaters comprise multiple elements to which control values for controlling a propagation state of a radio signal are applicable respectively, and
the controlling comprises specifying a codebook based on a configuration from the base station, the codebook defining a control value set as a set of the control values for each index value.

2. The communication method according to claim 1, wherein
the controlling further comprises
in response to the control terminal receiving the index value from the base station, deriving the control value set corresponding to the received index value based on the codebook, and
controlling the one or more repeaters to perform the beamforming using the derived control value set.

3. The communication method according to claim 1, wherein
the specifying comprises
receiving, by the control terminal, configuration information to configure the number of elements used for the beamforming from the base station, and
specifying the codebook corresponding to the configured number of elements from among a plurality of the codebooks individually defined in accordance with the number of elements.

4. The communication method according to claim 3, wherein
when the multiple elements are grouped into multiple groups, the configuration information indicates the number of elements constituting each group, and
the controlling comprises controlling the one or more repeaters to perform the beamforming for each of the multiple groups using the specified codebook.

5. The communication method according to claim 1, wherein
the specifying comprises
receiving, by the control terminal, configuration information to individually configure the codebook for each of the multiple repeaters from the base station, and
specifying the codebook for each of the repeaters based on the configuration information.

6. The communication method according to claim 1, wherein
when the multiple elements are grouped into multiple groups, the specifying comprises
receiving configuration information to individually configure the codebook for each of the multiple groups from the base station, and
specifying the codebook for each of the multiple groups based on the configuration information.

7. The communication method according to claim 1, wherein
when the number of the control values in the control value set is smaller than the number of elements used for the beamforming, the controlling comprises deriving a remaining number of control values by interpolating between the control values in the control value set.

8. A communication method used in a mobile communication system comprising a relay apparatus configured to be controlled by a network, the communication method comprising:
relaying, by one or more repeaters comprised in the relay apparatus, a radio signal from a base station to a user equipment through beamforming; and
controlling, by a control terminal comprised in the relay apparatus, the repeater by performing wireless communication with the base station,
wherein the one or more repeaters comprise multiple elements to which control values for controlling a propagation state of a radio signal are applicable respectively, and
the controlling comprises specifying a common control value set derived from multiple control value sets comprising a first control value set to form a first beam and a second control value set to form a second beam having a beam direction different from a beam direction of the first beam.

9. The communication method according to claim 8, wherein
the controlling further comprises controlling the one or more repeaters to form both the first beam and the second beam with the multiple elements by using the common control value set.

10. The communication method according to claim 8, wherein
the specifying comprises
acquiring, by the control terminal, the multiple control value sets from the base station, and
specifying the common control value set from the multiple control value sets acquired.

11. The communication method according to claim 8, wherein
the specifying comprises
notifying, by the control terminal, the base station of the multiple control value sets, and
specifying the common control value set by acquiring, from the base station, the common control value set derived by the base station based on the multiple control value sets.

12. The communication method according to claim 8, further comprising:
transmitting, at a user equipment, beam information indicating one or more beams satisfying a predetermined quality criterion from the user equipment to the base station,
wherein the specifying comprises specifying the common control value set by acquiring, by the control terminal from the base station, the common control value set derived by the base station based on the beam information.

13. The communication method according to claim 12, wherein
the transmitting the beam information comprises transmitting information indicating a beam other than a highest-quality beam from the user equipment to the base station.

14. A relay apparatus comprising a repeater and a control terminal configured to:
relay, by the repeater, a radio signal from a base station to a user equipment through beamforming; and
control, by the control terminal, the repeater by performing wireless communication with the base station,
wherein the repeater comprises multiple elements to which control values for controlling a propagation state of a radio signal are applicable respectively, and
wherein the control comprises specifying a common control value set derived from multiple control value sets comprising a first control value set to form a first beam and a second control value set to form a second beam having a beam direction different from a beam direction of the first beam.
